(19) United States
(12) Patent Application Publication
(10) Pub. No.: US 2026/0350597 A1
(43) Pub. Date: Nov. 5, 2026

(54) CROSS DEVICE IMPORTING

(71) Applicant: Coinbase, Inc., Oakland, CA (US)

(72) Inventors: Cody Crozier, Phoenix, AZ (US); Aaron Pollock, Palo Alto, CA (US); Garey Simpson, Marietta, GA (US); Jeffrey Daniel Hinojosa, Woodland Hills, CA (US); Alexander Shoykhet, San Francisco, CA (US)

(21) Appl. No.: 19/199,195

(22) Filed: May 5, 2025

(51) Int. Cl. G06Q 20/38; G06Q 20/36; G06Q 20/40; H04L 9/32

(52) U.S. Cl. CPC G06Q 20/3825; G06Q 20/36; G06Q 20/3829; G06Q 20/401; H04L 9/3228; H04L 9/3247

(57) ABSTRACT

Methods, systems, and devices for data management are described. A first user device for a blockchain network may communicate first signaling to initiate an import session for a blockchain wallet associated with a device-based passkey associated with a second user device, where the first signaling may include a random secret. The first user device may receive an indication that the import session is associated with the second user device and may generate a new passkey associated with the first user device. The first user device may transmit second signaling including an encrypted credential identifier associated with the new passkey, where the encrypted credential identifier may be encrypted based on the random secret. The second user device may sign a blockchain transaction authorizing access to the blockchain wallet using the new passkey, and the first user device may access the blockchain wallet using the new passkey.

### FIELD OF TECHNOLOGY

The present disclosure relates generally to data management, including techniques for cross device importing.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIG. 1 illustrates an example of a computing environment that supports cross device importing in accordance with aspects of the present disclosure.

FIG. 2 shows an example of a signaling environment that supports cross device importing in accordance with aspects of the present disclosure.

FIGS. 3-6 show examples of process flows that support cross device importing in accordance with aspects of the present disclosure.

FIG. 7 shows a block diagram of an apparatus that supports cross device importing in accordance with aspects of the present disclosure.

FIG. 8 shows a block diagram of a client application that supports cross device importing in accordance with aspects of the present disclosure.

FIG. 9 shows a diagram of a system including a device that supports cross device importing in accordance with aspects of the present disclosure.

FIGS. 10 through 13 show flowcharts illustrating methods that support cross device importing in accordance with aspects of the present disclosure.

### DETAILED DESCRIPTION

A wallet application may be used to access a wallet (e.g., blockchain wallet), which may store digital assets, such as crypto tokens, which are supported by blockchain networks. In some implementations, a wallet may be accessible at a device via the wallet application by a user using a passkey. In some cases, the passkey may be a device-based passkey, and a device-based passkey may not synchronize (e.g., may not be valid, usable) across different devices, platforms, operating systems, or any combination thereof. In some examples, a device-based passkey may be specific to a device or platform that a user may use to access the wallet (e.g., an origin device). However, in some cases, the user may change devices, platforms, operating systems, or any combination thereof or may wish to access the wallet on another device. The wallet may not be accessible from a wallet application associated with the new device, platform, or operating system, because the passkey may be a device-based passkey. For example, it may not be possible to share or export a passkey between devices, platforms, operating systems, or the like. Further, exporting or sharing a passkey between devices may expose the passkey to a variety of security risks.

Techniques described herein support access, on a target device, to a blockchain wallet that is associated with device-based passkey on an origin device. For example, using the origin device that already has wallet access, the described techniques support creation and authorization of a new passkey for a target device. This process adds the new passkey of the target device as an owner of the wallet, which may grant access to the wallet at the target device. For example, a target device may initiate an import session for the wallet with the origin device, which may include generating and sharing a random secret between the target device and the origin device. The target device and the origin advice may establish a secure session for communicating information using a QR code, a double one-time code (2×OTC) protocol, or the like. In some cases, establishing the secure session may include verification of the target device and origin device identities by the user. In some implementations, the target device may generate a new passkey, which may be based on some input from the user. After establishing the secure session and generating the new passkey, the target device may transmit an encrypted credential identifier (ID) associated with the new passkey, and an encrypted public key associated with the new passkey. In some cases, the credential ID may be encrypted using the random secret. The origin device may receive the encrypted credential ID, and may sign a transaction, using the device-based passkey, to add the new passkey as an owner of the wallet (e.g., by adding the public key associated with the new passkey to the list of owners). Signing the transaction may authorize the wallet to be accessed, via the target device, using the new passkey.

Particular aspects of the subject matter described in this disclosure can be implemented to realize one or more of the following potential advantages. In some examples, by implementing a system to allow for the generation of a new passkey associated with a wallet, the described techniques can be used to support an improved user experience and more intuitive and flexible design for users that may shift between devices, platforms, and operating systems for accessing a blockchain wallet. In some examples, by signaling an encrypted credential ID associated with the new passkey, the described techniques can be used to reduce security risks associated with signaling and sharing passkeys between devices. In some examples, by signing a transaction using the origin device-based passkey, the described techniques can be used to ensure the new passkey is securely and legitimately added as an owner of the wallet.

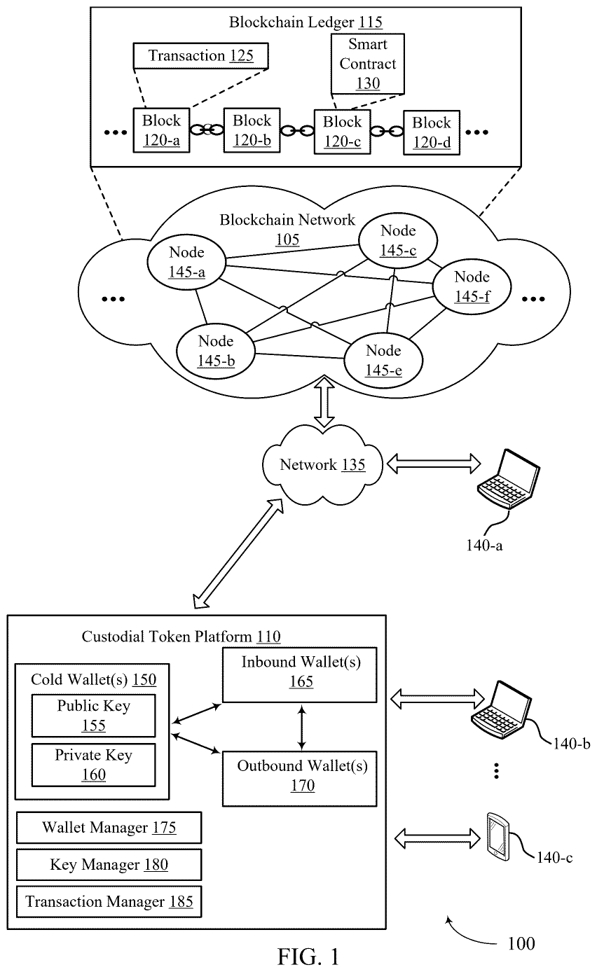

FIG. 1 illustrates an example of a computing environment 100 that supports cross device importing in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the computing system custodial token platform 110, the blockchain network 105, or both. For example, a user of the computing device 140-a may provide user inputs via the computing device 140-a, which may result in commands, data, or any combination thereof being communicated via the network 135 to the computing system custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols may have layer two and layer two functionality, and each layer may support or utilize different tokens. Layer one may refer to the underlying main blockchain architecture, and layer one solutions are improvements directly integrated into the codebase of a cryptocurrency's main blockchain. Layer one solutions, on the other hand, are built on top of layer one and may interact with the main blockchain but have their own architecture. Layer two solutions may support offload of processing from the main blockchain (layer one) to improve scalability and speed while retaining the robust security of the main chain. Additionally, smart contracts implemented on the blockchain networks may support different types of tokens, and the code of the smart contracts may control how tokens are spent, who can spend the tokens, and other conditions for transfer. Additionally, one or more smart contracts may support a decentralized application (“Dapp”) that facilitate various types of functionality. Accordingly, various types of tokens may be supported by a blockchain network.

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

As described herein, a wallet application on a computing device (e.g., computing device 140) may be used to access a wallet, which may store digital assets, such as crypto tokens, that are supported by blockchain networks 105. In some implementations, a wallet may be accessible at a device, such as a computing device 140, via the wallet application by a user using a passkey. In some cases, the passkey may be a device-based passkey. For example, a device-based passkey may not synchronize (e.g., may not be valid, usable) across different devices, platforms, operating systems, or any combination thereof. In some examples, a device-based passkey may be specific to a device or platform that a user may use to access the wallet (e.g., at an origin device). However, in some cases, the user may change devices, platforms, operating systems, or any combination thereof or wish to access the wallet on a different device, platform, or operating system. The wallet may not be accessible from a wallet application associated with the new device, platform, or operating system, because the passkey may be a device-based passkey. For example, it may not be possible to share or export a passkey between devices, platforms, operating systems, or the like. Further, exporting or sharing a passkey between devices may expose the passkey to a variety of security risks.

In some implementations, devices may support generating a new passkey for access to a wallet on a target device and authorizing the new passkey, using an origin device that already has access to the wallet via a wallet application, to be added as an owner of the wallet, enabling access to the wallet by the target device via a wallet application. In some examples, implementing a system to allow for the generation of a new passkey associated with a wallet may support an improved user experience and more intuitive and flexible design for users that may shift between devices, platforms, and operating systems for accessing a blockchain wallet.

For example, a target device may initiate an import session for the wallet with the origin device, which may include generating and sharing a random secret between the target device and the origin device. The target device and the origin advice may establish a secure session for communicating information using a QR code, a double one-time code (2×OTC) protocol, or the like. In some cases, establishing the secure session may include verification of the target device and origin device identities by the user. The target device may generate a new passkey, which may be based on some input from the user. After establishing the secure session and generating the new passkey, the target device may transmit an encrypted credential ID associated with the new passkey (e.g., the target device transmits an indication of the new passkey). In some cases, the credential ID may be encrypted using the random secret. In some examples, signaling an encrypted credential ID associated with the new passkey may reduce security risks associated with signaling and sharing passkeys between devices. The origin device may receive the encrypted credential ID, and may sign a transaction, using the device-based passkey, to add the new passkey as an owner of the wallet, and the transaction may be broadcast via the blockchain network 105. Signing and broadcasting the transaction may authorize the wallet to be accessed, via the target device, using the new passkey. In some examples, signing a transaction using the origin device-based passkey may ensure the new passkey is securely and legitimately added as an owner of the wallet.

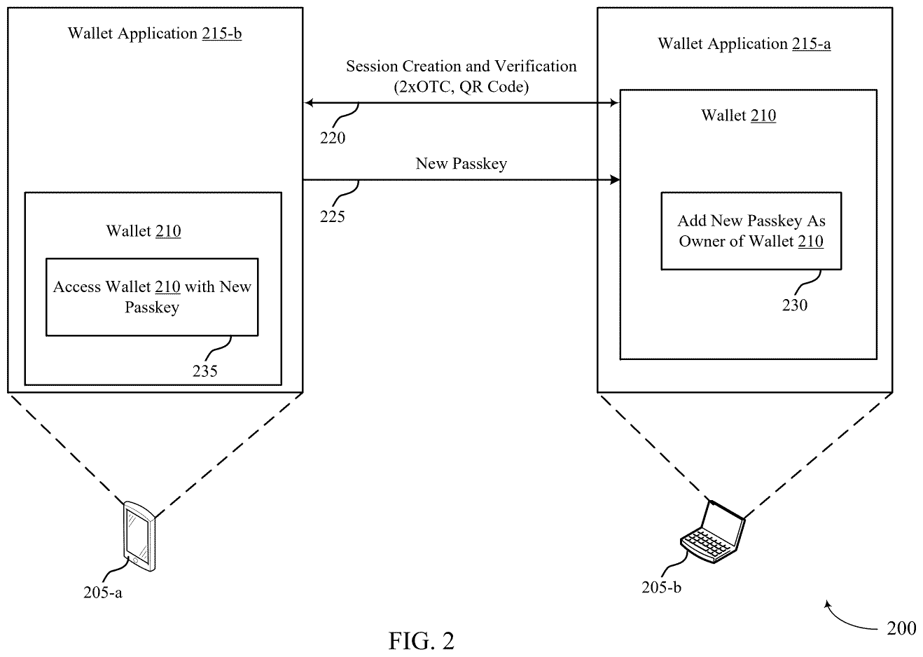

FIG. 2 shows an example of a signaling environment 200 that supports cross device importing in accordance with aspects of the present disclosure. The signaling environment 200 may implement or be implemented to realize aspects of the computing environment 100. For example, the signaling environment 200 may illustrate communication between devices 205-a and 205-b, which may be examples of corresponding devices described herein, including with reference to FIG. 1 (e.g., computing devices 140). Signaling environment 200 may support the import of a wallet (e.g., a blockchain wallet) to a target device 205-a based on adding a new passkey associated with the target device 405-a as an owner of the wallet.

In some implementations, an origin device 205-b and a target device 205-a may communicate. The origin device 205-b, which may be an example of a user computing device, may have access to a wallet 210 via a wallet application 215-a. The origin device 205-b may access the wallet 210, via the wallet application 215-a, using a passkey, which may be a key generated by an operating system that may comply with some rules or restrictions (e.g., WebAuthn standards). In some cases, the passkey used by the origin device 205-b may be a device-based passkey. For example, a user of the origin device 205-b may create the wallet 210 (e.g., smart contract wallet) using a device-based passkey. The device-based passkey may be a passkey that is generated and stored on the origin device 205-b (e.g., in a secure enclave accessible via authentication, such as biometric authentication) that may not synchronize across services, platforms, operating systems, browsers, or the like. For example, the device-based passkey may be specific to the origin device 205-b, or to a platform associated with the origin device 205-b (e.g., a cross device passkey, which may be synchronized across devices associated with a platform, operating system, browser, or the like). That is, the device-based passkey may be used to access the wallet 210 on the origin device 205-b, such as via the wallet application 215-a, but may not be valid for accessing the wallet 210 on a different device, such as the target device 205-a.

In some cases, the target device 205-a may access wallet application 215-b. A user of the target device 205-a, who may also be a user of the origin device 205-b, may want to access the wallet 210 via the wallet application 215-b. For example, a user may import the wallet 210 into the wallet application 215-b, which may be cross-device importing. However, the wallet 210 may be associated with the device-based passkey for the origin device 205-b, and the target device may not be able to access (e.g., sign in to, import) the wallet 210 on the target device 205-a. In order to access the wallet 210, the target device 205-a may communicate with the origin device 205-b to generate a new passkey, associated with the target device 205-a, and to add the new passkey as an owner for the wallet 210, allowing the target device 205-a to access the wallet 210 via the wallet application 215-b. That is, a user may add a passkey on a new device (e.g., the target device 205-a) to an existing wallet 210 on another device (e.g., the origin device 205-b).

In some implementations, a passkey may be associated with a passkey credential ID. A passkey credential ID may be a unique identifier for a passkey. Signaling a passkey credential ID, rather than the associated passkey, may increase security associated with the signaling of passkeys between devices. A passkey may also be associated with a passkey public key and a passkey private key, which may be used to sign and authorize transactions on the blockchain and between devices 205. For example, devices 205 may sign transactions using a passkey public key, which may act as owners or signers for a wallet 210 (e.g., a smart contract). That is, the owners or signers may indicate the passkey public keys that may represent authorized signers on the smart contract (e.g., the blockchain wallet). The passkey private key may be maintained at the associated device 205 and may not be signaled between devices 205.

In some implementations, in order to add access to the wallet 210 on the target device 205-a, the target device 205-a and the origin device 205-b may communicate signaling to initiate an import session for the wallet 210 between the devices 205. In some cases, the target device 205-a and the origin device 205-b may initiate an import session using OTCs, such as via a 2×OTC protocol, which may be part of an OTC session. An OTC session may describe a time frame between OTC generation and OTC confirmation on another device. A 2×OTC protocol may use OTC generation and OTC confirmation at both devices to confirm the initiation of the import session. In some examples, an OTC session may be time dependent or may be restricted to the duration of a timer before expiration of an associated OTC. In other cases, the target device 205-a and the origin device 205-b may initiate an import session using QR codes, which may be enacted during an OTC session.

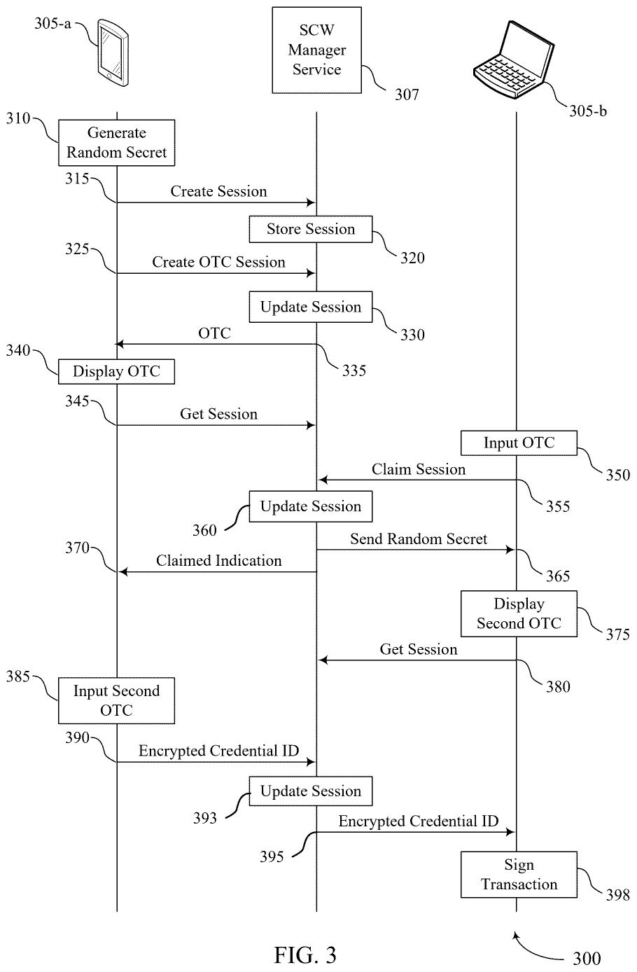

In some cases, in order to implement a 2×OTC protocol to create or initiate and verify an import session at 220, a target device 205-a may create and display a first OTC. The user may input the first OTC on the origin device 205-b, such as via a web browser or wallet application 215-a. When the first OTC is entered on the origin device 205-b, the origin device 205-b may display a second OTC. The user may input the second OTC at the target device 205-a, as described further at FIG. 3.

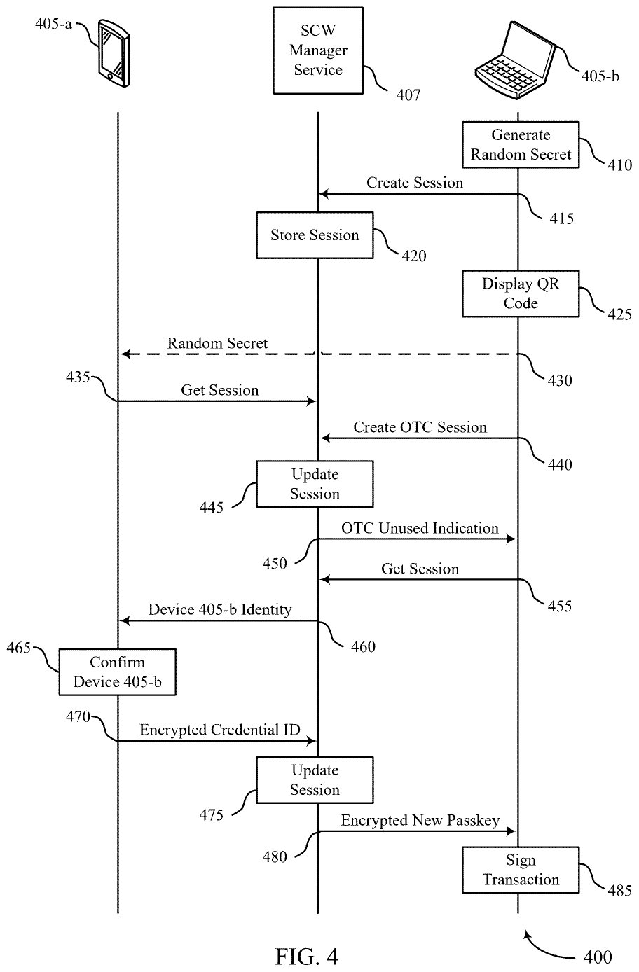

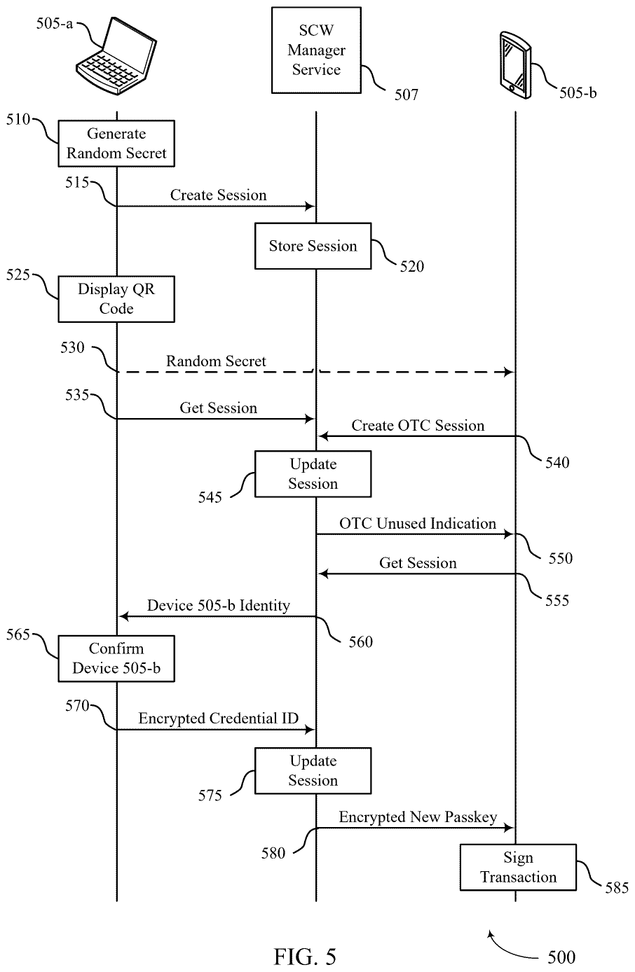

In other cases, in order to implement a QR code protocol to create or initiate and verify an import session at 220, a target device 205-a or an origin device 205-b may display a QR code. A user may use the other device 205 to scan the QR code, which may transfer information for the import session (e.g., session identifier, random secret), as described further with reference to FIGS. 4 and 5. For example, the origin device 205-b may display the QR code, and the user may scan the QR code with the target device 205-a, as described further at FIG. 4. Additionally, or alternatively, the target device 205-a may display the QR code, and the user may scan the QR code with the origin device 205-b, as described further at FIG. 5.

After the 2×OTC protocol or the QR code protocol is implemented to securely connect the origin device 205-b and the target device 205-a for the import session, the target device 205-a may generate a new passkey for the wallet 210. For example, the user may be prompted to input a new passkey at the wallet application 215-b. At 225, the new passkey may be indicated from the target device 205-a to the origin device 205-b. For example, the target device 205-a may transmit an encrypted passkey credential ID for the new passkey. In some examples, the passkey credential ID may be encrypted using a random secret associated with the import session. In some examples, the target device 205-a may transmit an encrypted passkey public key for the new passkey with the encrypted credential ID. The origin device 205-b may receive the encrypted passkey credential ID. In some cases, a smart contract wallet (SCW) manager service associated with the wallet 210 may aid in the transmission of signaling between the target device 205-a and the origin device 205-b, as described further at FIGS. 3-6. For example, the SCW manager service may store the OTC session and the import session, as well as aid in transmitting pertinent information between the devices 140.

After receiving the indication of the new passkey, the origin device 205-b may, at 230, sign a transaction to add the new passkey as an owner or signer for the wallet 210. For example, the user may be prompted to sign the transaction using the device-based passkey for the origin device 205-b. Signing the transaction may add the new passkey as an owner for the wallet 210 and may allow the target device 205-a to access, at 235, the wallet 210 using the new passkey.

In some implementations, the session generated or initiated by the devices 205 may be associated with security measures to reduce the risk of generating passkeys, sharing passkey information, and adding passkeys as owners to a wallet 210. For example, there may be some authenticated application programming interface (API) endpoints associated with the communication between the target device 205-a and the origin device 205-b that may be unauthenticated. An attacker device 140 may use the unauthenticated endpoints to access or initiate the import session.

In some cases, the initiation of the session may include a client that generates a random secret and session identifier (session ID) (e.g., sessionId). For example, the target device 205-a or the origin device 205-b may generate the random secret and session ID after initiation of the import session. In some examples, the device 205 may generate a unique session ID during the initial creation and initiation of the import session. For example, during an API call to create the import session (e.g., createSession), the device 205 may generate the session ID. A backend for the devices 205 may validate the session ID on any future unauthenticated calls via the unauthenticated endpoints. That is, the session ID may be included on each valid signal or call between the target device 205-a, the SCW manager service, and the origin device 205-b to ensure the device 205 that transmits a call is an authorized device 205.

In some cases, the device 205 may also generate a random secret during creation and initiation of the import session. The target device 205-a may use the random secret to encrypt the passkey information (e.g., credential ID, passkey public key), and the origin device 205-b may use the random secret to decrypt the encrypted passkey information. For example, the target device 205-a may transmit the new passkey data to a backend for storage, such that the new passkey may be indicated to the origin device 205-b. To prevent interception of the passkey information from a user or client of the backend service (e.g., a “man in the middle” attack), as well as manipulation of the passkey information during signaling, the target device 205-a may encrypt the passkey data using the random secret before transmitting it to the backend. For example, the passkey data (e.g., the public key and credential ID for the passkey) may be encrypted using an encryption scheme (e.g., AES256-GCM encryption). For a QR code protocol, the random secret may be directly signaled between the target device 205-a and the origin device 205-b, and thus there may not be enough information at the backend to support intercepting and decrypting the credential ID during a “man-in-the-middle” attack. For a 2×OTC protocol, the random secret may be stored on a backend to facilitate transmission of the random secret between the devices 205. However, the random secret may be deleted or removed from the database after the random secret may be transmitted to the relevant devices 205, and prior to the encrypted passkey information (e.g., encrypted credential ID, encrypted passkey public key) being signaled, which may reduce or remove the opportunity for a “man-in-the-middle” attack.

In some cases, such as when a QR code may be used to initiate an import session, the random secret may be generated on the device 205 that may display the QR code. The QR code may contain the secret and session ID. The other device 205 may scan the QR code to obtain the secret and session ID. The target device 205-a may encrypt the passkey data for the new passkey (e.g., the passkey public key and the credential ID for the new passkey) using the shared secret (e.g., the random secret). The target device 205-a may call a session (e.g., AttestOTCSession) in order to send the encrypted passkey public key, encrypted credential ID, and other parameters. In some examples, the target device 205-a may send the encrypted information to the SCW manager service. The origin device 205-b may poll for the passkey data using the random secret (e.g., the shared secret). Based on the passkey data, the origin device 205-b may update the signers (e.g., owners, public keys) for the wallet 210.

In other cases, such as when a 2×OTC protocol may be used to initiate an import session, the random secret may be generated on the target device 205-a. The target device 205-a may encrypt the public key and credential ID using the random secret. The target device 205-a may call a session (e.g., CreateSession, CreateOTCSession), which may include the secret in the payload. The origin device 205-b may receive the random secret as part of a response to an API call (e.g., ClaimOTCSession). The backend may delete the random secret based on the devices 205 both having the random secret. The target device 205-a may call a session (e.g., AttestOTCSession) to send the encrypted public key, encrypted credential ID, and other parameters. In some examples, the target device 205-a may send the encrypted information to the SCW manager service. The origin device 205-b may poll for the passkey data using the random secret (e.g., the shared secret). Based on the passkey data, the origin device 205-b may update the signers (e.g., owners, public keys) for the wallet 210.

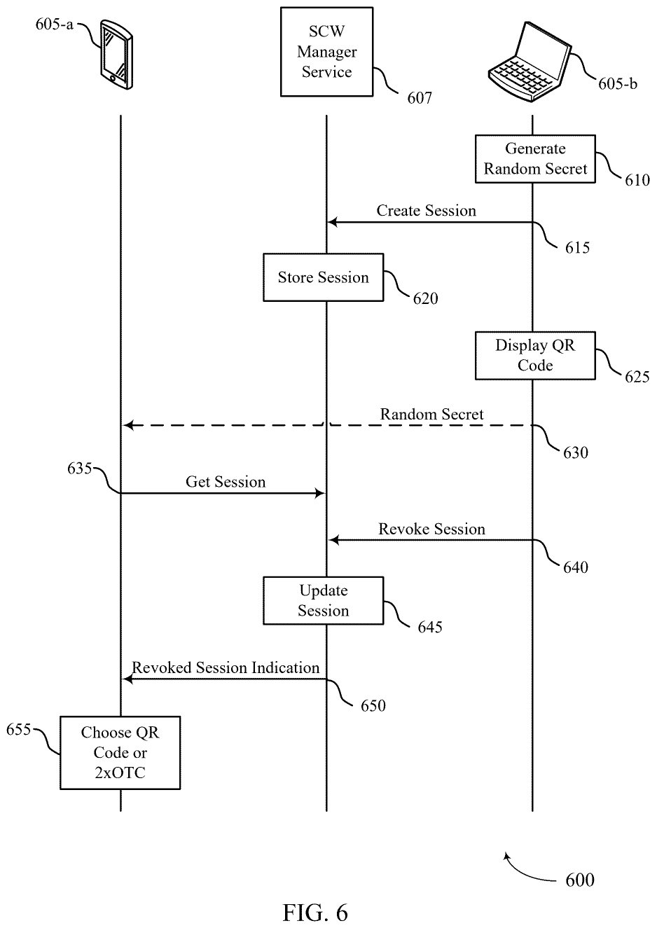

In some cases, a user may lose access to either device 205 during the import session. The import session may be canceled at either device 205. In some cases, the import session may be canceled after some time frame. In some cases, the origin device 205-b may cancel the import session. For example, the origin device 205-b may cancel a QR code implementation, and the target device 205-a may restart an import session, and may instead implement a 2×OTC protocol, as described with reference to FIG. 6.

In some implementations, the target device 205-a, origin device 205-b, or both may implement some session management or provider service, which may be implemented via the wallet applications 215. For example, a top-level context provider (e.g., OTCSessionProvider) may be implemented in a data layer and may store session states and expose data fetching functions. Implementing the same session management or provider service at the target device 205-a and the origin device 205-b may help maintain consistent and logical operations across different wallet applications 215. For example, the session management service may generate the random secret and session ID, create OTC sessions (e.g., transmit an API call to create the OTC session), and manage created OTC sessions via API callbacks or responses. Additionally, or alternatively, the session management service may poll for changes in states of the session, such as by transmitting API calls to get the session (e.g., getOTCSession, getSession). Different states may include unspecified, pre-initialization, initialized, claimed, attested, confirmed, and the like. Additionally, or alternatively, the session management service may claim and attest for OTC sessions. Additionally, or alternatively, the session management service may encrypt, decrypt, or both passkey information (e.g., credential ID, passkey public key). Additionally, or alternatively, the session management service may enable or facilitate the target device 205-a to restart an import session flow, as described further with reference to FIG. 6. For example, if a device 205 exits a session (e.g., becomes disconnected, loses power, or the like), or if a device 205 chooses to exit or revoke a session, the session management service may facilitate next operations for the devices 205.

FIG. 3 shows an example of a process flow 300 that supports cross device importing in accordance with aspects of the present disclosure. The process flow 300 may implement or be implemented to realize aspects of the computing environment 100 and the signaling environment 200. For example, the process flow 300 may illustrate communication between devices 305-a and 305-b, which may be examples of corresponding devices described herein, including with reference to FIG. 1 (e.g., computing devices 140) and FIG. 2 (e.g., device 205). Process flow 300 may support a 2×OTC protocol for adding a new passkey, associated with a target device 305-a, as an owner of a blockchain wallet.

In some implementations, devices 305 may communicate in order to generate and authorize a passkey to allow a target device 305-a to access a wallet (e.g., blockchain wallet), where the wallet may be accessible at an origin device 305-b using a device-based passkey. For example, the target device 305-a may import a wallet associated with the origin device 305-b based on generating a new passkey and the origin device 305-b signing a transaction to add the new passkey as an owner of the blockchain wallet. In some cases, a SCW manager service 307 may facilitate communication between the target device 305-a and the origin device 305-b. In some cases, the target device 305-a, the origin device 305-b, or both may be mobile devices, desktop devices, or other examples of devices.

In some implementations, to initiate an import session between the target device 305-a and the origin device 305-b, the devices 305 may use protocols, such as a 2×OTC protocol or a QR code protocol, to securely initiate the import session. Process flow 300 may be an example of a 2×OTC procedure for performing cross device importing for a blockchain wallet between the target device 305-a and the origin device 305-b, facilitated by the SCW manager service 307.

In some implementations, at 310, the target device 305-a (e.g., a first device) may generate a random secret. In some cases, the target device 305-a may also generate a session ID (e.g., session_id). The session ID may be used to indicate messages associated with allowed devices 305 during the cross device import session for the wallet and may improve security for communication between the devices 305.

At 315, the target device 305-a may transmit (e.g., communicate) first signaling to initiate an import session for a blockchain wallet associated with a device-based passkey, where the first signaling may include the random secret and where the device-based passkey may be associated with an origin device 305-b (e.g., a second device). For example, the target device 305-a may transmit an API call to create a session (e.g., createSession) to the SCW manager service 307. The payload of the API call may include the random secret and the session ID, or an indication of the random secret and the session ID. In some examples, the payload of the API call may include an identifier for the target device 305-a (e.g., deviceName). In some cases, the device-based passkey associated with the origin device 305-b may include a passkey for the origin device 305-b, a cloud-based passkey associated with a first operating system for the origin device 305-b, or any combination thereof.

In some cases, the target device 305-a may receive one or more API responses to the API call to create the session, which may include the session ID, an indication of a state for the session (e.g., pre-initialized), an OTC (e.g., a randomly generated 7 digit number), a location indication for the target device 305-a (e.g., target_geo, mapped city code), an IP address indication (e.g., target_network), the identifier for the target device 305-a, an agent associated with the target device 305-a (e.g., target_userAgent), one or more time stamps or time indications for the session (e.g., CreatedAt, UpdatedAt), or any combination thereof.

In some implementations, at 320, the SCW manager service 307 may, based on receiving the API call to create the session from the target device 305-a at 315, store the session. For example, the SCW manager service 307 may store the random secret, the session ID, and one or more associated parameters. In some examples, the SCW manager service 307 may store an indication of the 2×OTC protocol (e.g., requiresExtraOTC may be True).

Additionally, or alternatively, the SCW manager service 307 may store an indication of a status of the session, which may be pre-initialization (e.g., pre-init).

In some implementations, at 325, the target device 305-a may transmit, to the SCW manager service 307, an API call to create an OTC session (e.g., createOTCSession). In some cases, the API call to create the OTC session may include the session ID and information indicative of the target device 305-a (e.g., target_context: {device_name, location}). For example, the target device 305-a may prompt a user to scan a QR code or to display an OTC code. The user may input a selection to display the OTC, which may prompt an API call to the SCW manager service 307 to initiate an OTC session.

In some implementations, at 330, the SCW manager service 307 may update the session based on receiving the API call to create the OTC session at 325. For example, the SCW manager service 307 may update the session such that the previous session (e.g., the session stored at 320) may be updated to include an OTC (e.g., otc1) and a state may be updated, such as to initialized (e.g., init).

In some implementations, at 335, the SCW manager service 307 may transmit the OTC to the target device 305-a. In some cases, at 335, the SCW manager service 307 may transmit the OTC to the target device 305-a as part of a response to the API call to create the OTC session at 325. The response may include the session ID, an indication of a state (e.g., initialized), the OTC, a location indication (e.g., target_geo, mapped city code), an IP address indication (e.g., target_network), the identifier for the target device 305-a, an agent associated with the target device 305-a (e.g., target_userAgent), one or more time stamps or time indications (e.g., CreatedAt, UpdatedAt), or any combination thereof. In some examples, when the state may be indicated as initialized, the OTC may expire after a duration of a timer (e.g., 30 seconds). If the OTC expires, the target device 305-a may transmit a new API call to create an OTC session, as at 325, and may receive a new OTC in response.

In some implementations, at 340, the target device 305-a may display the OTC (e.g., received at 335), which may be associated with initiation of the import session (e.g., the session). For example, a user interface at the target device 305-a may display an OTC code.

In some implementations, at 345, the target device 305-a may transmit (e.g., after displaying the OTC) an API call to get the session (e.g., getSession), which may include the session ID. The API call to get the session may be a long poll, which may allow the target device 305-a to monitor for or wait for a response to the long poll, such as for a defined period of time, until the OTC session may be claimed by the origin device 305-b. The payload of the API call to get the session may further include an identifier for the target device 305-a (e.g., deviceName). In some cases, the target device 305-a may receive a response to the API call to get the session (e.g., at 345), which may include the session ID, an indication of the state of the session (e.g., initialized), the OTC, a location indication (e.g., target_geo, mapped city code), an IP address indication (e.g., target_network), the identifier for the target device 305-a, an agent associated with the target device 305-a (e.g., target_userAgent), one or more time stamps or time indications (e.g., CreatedAt, UpdatedAt), or any combination thereof. The target device 305-a may continue to poll (e.g., transmit an API call to get the session) until a response indicates that the session is claimed (e.g., the state is claimed), as at 370.

In some implementations, at 350, the origin device 305-b may receive the OTC. For example, the origin device 305-b may display a user interface for the user to input (e.g., enter) the OTC. The origin device 305-b may receive the input (e.g., the OTC).

At 355, the origin device 305-b may transmit an API call to claim the session (e.g., claimOTCSession, ClaimImportSession), which may be an authorized call. The API call to claim the session may include the OTC and information about the origin device 305-b (e.g., origin_context: {device_name, address}, where the address may be the wallet address for the user (e.g., baseContractAddress)). In some cases, the API call at 355 may be an indication that the import session may be associated with the origin device 305-b (e.g., the origin device 305-b may transmit the indication). For example, the origin device 305-b may transmit an indication that the import session is claimed by the origin device 305-b in accordance with the user input at 350.

In some implementations, at 360, the SCW manager service 307 may update the session based on receiving the API call to claim the session from the origin device 305-b. For example, the SCW manager service 307 may update the previous session by updating the state to claimed and generating a second OTC. Further, the SCW manager service 307 may update the session to include that the secret (e.g., the random secret) may be null. For example, the SCW manager service 307 may transmit an indication of the random secret, as at 365, and the SCW manager service 307 may delete the secret, such that only the target device 305-a and the origin device 305-b may know the secret.

At 365, the SCW manager service 307 may transmit an indication of the random secret to the origin device 305-b. In some implementations, the origin device 305-b may receive (e.g., communicate) signaling (e.g., first signaling) that may initiate the import session for the blockchain wallet associated with a device-based passkey, where the signaling may include the random secret, and where the device-based passkey may be associated with the origin device 405-b. In some cases, the SCW manager service 307 may delete the random secret (e.g., mark the secret as null). The indication of the random secret may also include the session ID, the OTC, the second OTC, and information about the target device 305-a (e.g., target_context). In some cases, the origin device 305-b may receive the random secret as part of a response to the API call to claim the session (e.g., as at 355), which may include the session ID, an indication of the state (e.g., claimed), the OTC, the second OTC, an indication of the OTC attestation (OTC_attest), the random secret, a location indication for the target device 305-a (e.g., target_geo, mapped city code), an IP address indication (e.g., target_network), the identifier for the target device 305-a, an agent associated with the target device 305-a (e.g., target_userAgent), information associated with the origin device 305-b, one or more time stamps or time indications (e.g., CreatedAt, UpdatedAt), or any combination thereof. In some examples, the information about the origin device 305-b may include a location indication for the origin device 305-b (e.g., origin_geo, mapped city code), an IP address indication for the origin device 305-b (e.g., origin_network), the identifier for the origin device 305-b, an agent associated with the origin device 305-b (e.g., origin_userAgent), the wallet address for the user (e.g., baseContractAddress), or any combination thereof.

At 370, the target device 305-a may receive an indication that the session (e.g., import session) may be associated with origin device 305-b. In some cases, the target device 305-a may receive an indication that the session is claimed by the origin device 305-b in accordance with displaying the OTC at 340. For example, the SCW manager service 307 may transmit, to the target device 305-b, an indication that the session has been claimed. For example, the SCW manager service 307 may transmit an API response for the long poll at the target device 305-a, as described at 345, indicating that the session may be claimed. In some cases, the API response may include the session ID, an indication of the state of the session (e.g., claimed), the OTC, the second OTC, a location indication (e.g., target_geo, mapped city code), an IP address indication (e.g., target_network), the identifier for the target device 305-a, an agent associated with the target device 305-a (e.g., target_userAgent), information about the origin device 305-b, one or more time stamps or time indications (e.g., CreatedAt, UpdatedAt), or any combination thereof. In some examples, the information about the origin device 305-b may include a location indication (e.g., origin_geo, mapped city code), an IP address indication (e.g., origin_network), the identifier for the origin device 305-b, an agent associated with the origin device 305-b (e.g., origin_userAgent), the wallet address for the user (e.g., baseContractAddress), or any combination thereof.

In some implementations, at 375, the origin device 305-b may display the second OTC based on receiving the random secret at 365. For example, the API response including the random secret may also include an indication of the second OTC.

In some implementations, at 380, the origin device 305-b may transmit (e.g., after displaying the second OTC) an API call to get the session (e.g., getSession), which may include the session ID. The API call to get the session may be a long poll, which may allow the origin device 305-b to monitor for or wait for a response to the long poll, such as for a defined period of time, until the second OTC may be input at the target device 305-a (e.g., a state of “attested” is returned in response to the API call). In some cases, the API call to get the session may also include an identifier of the origin device 305-b (e.g., deviceName).

In some implementations, at 385, the target device 305-a may receive the second OTC. For example, the target device 305-a may display a user interface component for entering (e.g., inputting) the second OTC displayed by the origin device 305-b. The target device 305-a may receive user input (e.g., via the user interface component) including the second OTC, where the user input may confirm an identity of the origin device 305-b. For example, when the poll for the API call to get the session at 345 returns a response indicating a claimed state, as at 370, the target device 305-a may display a screen for entering the second OTC.

At 390, the target device 305-a may transmit second signaling that may include an encrypted credential ID associated with a new passkey for accessing the blockchain wallet, where the encrypted credential ID may be encrypted based on the random secret. For example, based on receiving the user input at 385, the target device 305-a may transmit an indication of an encrypted credential ID for a new passkey for the wallet to the SCW manager service 307. In some cases, the target device 305-a may generate, in accordance with receiving the claimed indication at 370, a new passkey associated with the target device 305-a, where the new passkey may allow access to the blockchain wallet. In some examples, the new passkey may include a device-based passkey (e.g., a second device-based passkey) associated with the target device 305-a, where the device-based passkey associated with the target device 305-a may include a passkey for the target device 305-a, a cloud-based passkey associated with a second operating system for the target device 305-a where the second operating system may be different from the first operating system (e.g., as described at 315), or any combination thereof. In some cases, the target device 305-a may encrypt a credential ID associated with the new passkey using the random secret. For example, the target device 305-a may display a user interface for the user to input the new passkey. The target device 305-a may determine a credential ID associated with the new passkey and may encrypt the credential ID using the random secret.

At 390, the target device 305-a may transmit the encrypted credential ID to the SCW manager service 307. In some cases, the target device 305-a may transmit the session ID, the second OTC, and a public key (e.g., passkey public key) associated with the new passkey with the encrypted credential ID. For example, at 390, the target device 305-a may transmit an API call to attest the import session, which may include the session ID, an OTC attestation indication (OTC_attest), the identifier for the target device 305-a, the wallet address for the user, the encrypted public key associated with the new passkey, the encrypted credential ID for the new passkey, an Authenticator Attestation Global Unique ID (AAGUID) for the new passkey, an indication of if the new passkey may be eligible to be backed up (e.g., passkeyIsBackupEligible), or any combination thereof. In some cases, the target device 305-a may receive a response to the API call to attest the session, which may include the session ID, an indication of a state (e.g., attested), the OTC, a location indication (e.g., target_geo, mapped city code), an IP address indication (e.g., target_network), the identifier for the target device 305-a, an agent associated with the target device 305-a (e.g., target_userAgent), information about the origin device 305-b, one or more time stamps or time indications (e.g., CreatedAt, UpdatedAt), or any combination thereof. In some examples, the information about the origin device 305-b may include a location indication (e.g., origin_geo, mapped city code), an IP address indication (e.g., origin_network), the identifier for the origin device 305-b, an agent associated with the origin device 305-b (e.g., origin_userAgent), the wallet address for the user (e.g., baseContractAddress), or any combination thereof.

In some implementations, at 393, the SCW manager service 307 may update the session based on receiving the encrypted credential ID. For example, for the 2×OTC protocol (e.g., if requiresExtraOTC is True), if the second OTC received from the target device 305-a matches the second OTC generated by the SCW manager service 307 and displayed at the origin device 305-b, the session state may be updated to attested.

At 395, the SCW manager service 307 may transmit the encrypted credential ID to the origin device 305-b. That is, the origin device 305-b may receive signaling (e.g., second signaling) that may include the encrypted credential ID associated with the new passkey for the blockchain wallet, where the new passkey may be associated with the target device 305-a and where the encrypted credential identifier may be encrypted based on the random secret. For example, the origin device 305-b may receive a response to the long poll initiated with the API call to get the session at 380. The response may include the public key associated with the new passkey and the credential ID encrypted with the random secret. In some cases, the response to the API call to get the session may include the public key associated with the new passkey, the encrypted credential ID for the new passkey, an AAGUID for the new passkey, an indication of if the new passkey may be eligible to be backed up (e.g., passkeyIsBackupEligible), the session ID, an indication of a state (e.g., attested), the OTC, the second OTC, a location indication (e.g., target_geo, mapped city code), an IP address indication (e.g., target_network), the identifier for the target device 305-a, an agent associated with the target device 305-a (e.g., target_userAgent), information about the origin device 305-b, one or more time stamps or time indications (e.g., CreatedAt, UpdatedAt), or any combination thereof. In some examples, the information about the origin device 305-b may include a location indication (e.g., origin_geo, mapped city code), an IP address indication (e.g., origin_network), the identifier for the origin device 305-b, an agent associated with the origin device 305-b (e.g., origin_userAgent), the wallet address for the user (e.g., baseContractAddress), or any combination thereof. In some cases, receiving the encrypted credential ID at the origin device 305-b may be indicative of a confirmation of an identity of the origin device 305-b based on the identifier for the origin device 305-b.

At 398, the origin device 305-b may sign a transaction (e.g., blockchain transaction) that may add the new passkey as an owner of the wallet. For example, the origin device 305-b may display a user interface confirming the addition of the public key and associated credential ID to the list of owners for the wallet. In some cases, the user interface may confirm the identity of the target device 305-a (e.g., target_context) via the user interface. For example, the wallet application at the origin device 305-b may present the user with a transaction that may add the owner (e.g., public key) to the smart contract for the wallet (e.g., via AddOwner). The user may approve and sign the transaction, and a front end associated with the origin device 305-b may send the API call to update the signers (e.g., updateSigners). The API call to update the signers may include the wallet address for the user, the new signers (e.g., addSigners), a network ID (e.g., initialNetworkID), a signature (e.g., signedUserOp), a unique API identifier (e.g., Nonce), or any combination thereof. The response to the API call to update the signers may include an indication of the SCW account (e.g., SCWAccount).

In some implementations, after the origin device 305-b may sign the transaction and update the signers, the origin device 305-b may transmit an API call to confirm the import session, which may include the session ID and the identifier for the origin device 305-b. A response to the API call to confirm the import session may include the session ID, an indication of a state (e.g., confirmed), the OTC, the second OTC, a location indication (e.g., target_geo, mapped city code), an IP address indication (e.g., target_network), the identifier for the target device 305-a, an agent associated with the target device 305-a (e.g., target_userAgent), information about the origin device 305-b, one or more time stamps or time indications (e.g., CreatedAt, UpdatedAt), or any combination thereof. In some examples, the information about the origin device 305-b may include a location indication (e.g., origin_geo, mapped city code), an IP address indication (e.g., origin_network), the identifier for the origin device 305-b, an agent associated with the origin device 305-b (e.g., origin_userAgent), the smart wallet address for the user (e.g., baseContractAddress), or any combination thereof. The origin device 305-b may display an indication that the new passkey may have been successfully added as an owner for the wallet.

After the origin device 305-b may sign the transaction, the target device 305-a may access the blockchain wallet using the new passkey in accordance with transmitting the encrypted credential ID (e.g., second signaling), as described at 390. In some cases, the target device 305-a may receive information indicative of the new passkey being added as owner of the blockchain wallet, where access of the blockchain wallet using the new passkey may be in accordance with the new passkey being added as owner of the blockchain wallet. For example, the target device 305-a may poll to get the import session and may wait to receive an indication that the state has been updated to confirmed. The poll may include the session ID and the identifier for the target device 305-a. The response may include the session ID, an indication of a state (e.g., confirmed), the OTC, the second OTC, a location indication (e.g., target_geo, mapped city code), an IP address indication (e.g., target_network), the identifier for the target device 305-a, the agent associated with the target device 305-a (e.g., target_userAgent), information about the origin device 305-b, one or more time stamps or time indications (e.g., CreatedAt, UpdatedAt), or any combination thereof. In some examples, the information about the origin device 305-b may include a location indication (e.g., origin_geo, mapped city code), an IP address indication (e.g., origin_network), the identifier for the origin device 305-b, an agent associated with the origin device 305-b (e.g., origin_userAgent), the wallet address for the user (e.g., baseContractAddress), or any combination thereof. After the state is returned as confirmed, the passkey may be associated with the wallet (e.g., SCWAccount), and may be used as a valid authentication token to sign the user in to the wallet via the target device 305-a.

FIG. 4 shows an example of a process flow 400 that supports cross device importing in accordance with aspects of the present disclosure. The process flow 400 may implement or be implemented to realize aspects of the computing environment 100, the signaling environment 200, and the process flow 300. For example, the process flow 400 may illustrate communication between devices 405-a and 405-b, which may be examples of corresponding devices described herein, including with reference to FIGS. 1-3. Process flow 400 may support an origin device-initiated QR code protocol for adding a new passkey, associated with a target device 405-a, as an owner of a blockchain wallet.

In some implementations, devices 405 may communicate to generate and authorize a passkey to allow a target device 405-a to access a wallet (e.g., blockchain wallet), where the wallet may be accessible at an origin device 405-b using a device-based passkey. For example, the target device 405-a may import a wallet associated with the origin device 405-b based on generating a new passkey and the origin device 405-b signing a transaction to add the new passkey as an owner of the wallet. In some cases, an SCW manager service 407 may facilitate communication between the target device 405-a and the origin device 405-b. In some cases, the target device 405-a, the origin device 405-b, or both may be mobile devices, desktop devices, or other examples of devices.

In some implementations, to initiate an import session between the target device 405-a and the origin device 405-b, the devices 405 may use protocols, such as a 2×OTC protocol or a QR code protocol, to securely initiate the import session. Process flow 400 may be an example of a QR code procedure for performing cross device importing for a blockchain wallet between the target device 405-a, which may be an example of a mobile device, and the origin device 405-b, which may be an example of a desktop device.

In some implementations, a user may attempt to access the wallet via a wallet application on the target device 405-a (e.g., first device). The wallet application may prompt the user to scan a QR code at the origin device 405-b (e.g., second device). For example, the target device 405-a may display a network address to be opened on the origin device 405-b by the user.

In some implementations, at 410, the origin device 405-b may generate a random secret. In some cases, the origin device 405-b may also generate a session ID (e.g., session_id). The session ID may be used to indicate messages associated with allowed devices during the cross device import session for the wallet and may improve security for communication between the devices 405.

At 415, the origin device 405-b (e.g., a second device) may transmit, to the SCW manager service 407, signaling (e.g., third signaling) that may include a session ID associated with an import session. For example, the origin device 405-b may transmit an API call to create a session (e.g., import session) (e.g., createSession) to the SCW manager service 407. A payload of the API call may include the session ID. In some examples, the payload of the API call may also include an identifier for the origin device 405-b (e.g., deviceName), and may indicate that the QR code protocol may be implemented, rather than the 2×OTC protocol (e.g., RequiresDoubleOTC may be false). In some cases, the origin device 405-b may receive one or more API responses to the API call to create the session, which may include the session ID, an indication of a state for the session (e.g., pre-initialized), an OTC (e.g., a randomly generated 7 digit number), a location indication for the origin device 405-b (e.g., origin_geo, mapped city code), an IP address indication (e.g., origin_network), the identifier for the origin device 405-b, an agent associated with the origin device 405-b (e.g., origin_userAgent), one or more time stamps or time indications for the session (e.g., CreatedAt, UpdatedAt), or any combination thereof.

In some implementations, at 420, the SCW manager service 407 may store the session based on receiving the API call to create the session from the origin device 405-b at 415. For example, the SCW manager service 407 may store the session ID and one or more associated parameters. For example, the SCW manager service 407 may store an indication of the QR code protocol (e.g., requiresExtraOTC may be False). Additionally, or alternatively, the SCW manager service 407 may store an indication of a status of the session, which may be pre-initialization (e.g., pre-init). Additionally, or alternatively, the SCW manager service 407 may store an indication that the random secret may not be signaled to or stored at the SCW manager service 407 (e.g., secret may be null). For example, the random secret may be shared directly between the origin device 405-b and the target device 405-a using a QR code, as described at 425, 430, and 435. This may increase security and reduce the risk of a “man-in-the-middle” attack during the signaling of an encrypted credential ID, as described at 475 and 480. In some cases, the SCW manager service 407 may transmit the response to the API call to create the session, as described at 415, based on storing the session at 420.

In some implementations, at 425, the origin device 405-b may display an image that may include information that may encode the random secret and the session ID. For example, the origin device 405-b may display a QR code.

At 430, the origin device 405-b may communicate, with the target device 405-a, signaling (e.g., first signaling) to initiate an import session for the wallet associated with a device-based passkey, where the signaling may include the random secret and where the device-based passkey may be associated with the origin device 405-b (e.g., second device). In some cases, the target device 405-a may obtain, from an image sensor of the target device 405-a, an imaging including information that encodes the random secret. For example, the target device 405-a may scan a QR code that encodes the random secret, which may result in the transfer of the random secret (e.g., QR code secret) from the origin device 405-b to the target device 405-a. In some cases, the device-based passkey associated with the origin device 405-b may include a passkey for the origin device 405-b, a cloud-based passkey associated with a first operating system for the origin device 405-b, or any combination thereof. In some cases, the signaling may include the session ID. For example, the QR code may encode both the random secret and the session ID.

In some implementations, at 435, the target device 405-a may transmit an API call to get the session (e.g., getOTCSession), which may include the session ID. The API call to get the session may be a long poll, such that the target device 405-a may periodically poll the session until the target device 405-a may receive a response to the API call to get the session indicating that the state of the session is initialized.

In some implementations, at 440, the origin device 405-b may transmit, to the SCW manager service, an API call to create an OTC session (e.g., createOTCSession). In some cases, the API call to create the OTC session may include the session ID, information indicative of the origin device 405-b (e.g., origin_context: {device_name, location}), an indication of the address of the wallet (e.g., wallet address) for the user (e.g., baseContractAddress), or any combination thereof. For example, the target device 405-a may prompt a user to scan a QR code or to display an OTC code. The user may scan the QR code, as described at 430, which may prompt an API call to the SCW manager service 407 to initiate an OTC session. In some cases, the API call to create the OTC session at 440, or the API call to create the session at 415, may be an indication that the import session may be associated with the origin device 405-b.

In some implementations, at 445, the SCW manager service 407 may update the session based on receiving the API call to create the OTC session at 440. For example, the SCW manager service 407 may update the session such that the previous session (e.g., the session stored at 425) may be updated to include an OTC (e.g., otc1) and a state may be updated, such as to initialize (e.g., init). In some implementations, the updated state may prompt the SCW manager service 407 to transmit a response to the API call from the target device 405-a to get the session at 435. The response may include the session ID, an indication of a state for the session (e.g., initialized), the OTC, a location indication for the origin device 405-b (e.g., origin_geo, mapped city code), an IP address indication (e.g., origin_network), the identifier for the origin device 405-b, an agent associated with the origin device 405-b (e.g., origin_userAgent), one or more time stamps or time indications for the session (e.g., CreatedAt, UpdatedAt), the wallet address for the user, or any combination thereof.

In some implementations, the target device 405-a may further transmit an API call to claim the import session based on receiving the response, which may include the OTC, the identifier for the target device 405-a, and the address of the blockchain wallet for the user. The SCW manager service 407 may update the session based on receiving the API call to claim the OTC session, such that the previous session (e.g., the session stored at 445) state may be updated to claimed. The SCW manager service 407 may transmit a response to the API call to claim the import session, which may include the session ID, an indication of a state for the session (e.g., claimed), the OTC, an indication that the OTC may be attested by the origin device 405-b (e.g., OTC-attest), a location indication for the origin device 405-b (e.g., origin_geo, mapped city code), an IP address indication (e.g., origin_network), the identifier for the origin device 405-b, an agent associated with the origin device 405-b (e.g., origin_userAgent), one or more time stamps or time indications for the session (e.g., CreatedAt, UpdatedAt), the address of the blockchain wallet for the user, information associated with the target device 405-a, or any combination thereof. The information associated with the target device 405-a may include a location indication (e.g., target_geo, mapped city code), an IP address indication (e.g., target_network), the identifier for the target device 405-a, the agent associated with the target device 405-a (e.g., target_userAgent), or any combination thereof.

In some implementations, at 450, the SCW manager service 407 may transmit an indication that the OTC or a second OTC may be unused to the origin device 405-b. For example, the SCW manager service 407 may transmit, in response to the API call to create the OTC session at 440, the OTC to the origin device 405-b, as well as an indication that the OTC may be unused based on one or more parameters for the QR code protocol (e.g., requiresExtraOTC is False). The response may include the session ID, an indication of a state for the session (e.g., initialized), the OTC, a location indication for the origin device 405-b (e.g., origin_geo, mapped city code), an IP address indication (e.g., origin_network), the identifier for the origin device 405-b, an agent associated with the origin device 405-b (e.g., origin_userAgent), one or more time stamps or time indications for the session (e.g., CreatedAt, UpdatedAt), or any combination thereof.

In some implementations, at 455, the origin device 405-b may transmit an API call to get the session (e.g., getSession), which may include the session ID. The API call to get the session may be a long poll, which may allow the origin device 405-b to monitor for or wait for a response to the long poll, such as for a defined period of time, until the OTC session may be claimed by the target device 405-a. The payload of the API call to get the session may further include an identifier for the origin device 405-b (e.g., deviceName).

In some implementations, at 460, the target device 405-a may receive an indication that the session may be associated with the origin device 405-b. In some cases, at 460, the indication that the import session may be associated with the origin device 405-b may include an information associated with the origin device 405-b. For example, the target device 405-a may receive an indication of the identity of the origin device 405-b (e.g., origin_context). In some cases, the indication may be a response to the long poll to get the session at 440, or a response to the API call to claim the import session. The response may include the session ID, an indication of a state for the session (e.g., initialized, claimed), the OTC, an indication of the OTC attestation (e.g., OTC_attest), a location indication for the origin device 405-b (e.g., origin_geo, mapped city code), an IP address indication (e.g., origin_network), the identifier for the origin device 405-b, an agent associated with the origin device 405-b (e.g., origin_userAgent), one or more time stamps or time indications for the session (e.g., CreatedAt, UpdatedAt), the address of the blockchain wallet for the user, information associated with the target device 405-a, or any combination thereof. The information associated with the target device 405-a may include a location indication (e.g., target_geo, mapped city code), an IP address indication (e.g., target_network), the identifier for the target device 405-a, the agent associated with the target device 405-a (e.g., target_userAgent), or any combination thereof.

In some implementations, at 465, the target device 405-a may confirm the identity of the origin device 405-b. For example, the target device 405-a may display the identifier for the origin device 405-b and a user interface component associated with confirmation of the identifier for the origin device 405-b. The target device 405-a may receive user input selecting the user interface component, wherein the user input may confirm the identifier for the origin device 405-b.

In some implementations, the target device 405-a may generate, in accordance with confirming the identity of the origin device 405-b at 465, a new passkey associated with the target device 405-a, where the new passkey may allow access to the blockchain wallet. In some examples, the new passkey may include a device-based passkey (e.g., a second device-based passkey) associated with the target device 405-a, where the device-based passkey associated with the target device 405-a may include a passkey for the target device 405-a, a cloud-based passkey associated with a second operating system for the target device 405-a where the second operating system may be different from the first operating system, or any combination thereof. In some cases, the target device 405-a may encrypt a credential ID associated with the new passkey using the random secret. For example, the target device 405-a may display a user interface for the user to input the new passkey. The target device 405-a may determine a credential ID associated with the new passkey and may encrypt the credential ID using the random secret.

At 470, the target device 405-a may transmit second signaling including the encrypted credential ID associated with the new passkey for the blockchain wallet, where the encrypted credential ID may be encrypted based on the random secret. For example, based on receiving the user input at 465, the target device 405-a may transmit an indication of an encrypted credential ID for the new passkey for the blockchain wallet to the SCW manager service 407. In some cases, the second signaling may include an API call to attest the session based on verifying the identity of the origin device 405-b. The API call to attest the session (e.g., attestImportSession) may include the session ID, the identifier for the target device 405-a, the public key (e.g., passkey public key) associated with the new passkey, the encrypted credential ID for the new passkey, an AAGUID for the new passkey, an indication of if the new passkey may be eligible to be backed up (e.g., passkeyIsBackupEligible), or any combination thereof. In some cases, the target device 405-a may receive a response to the API call to attest the import session, which may include the session ID, an indication of a state for the session (e.g., attested), the OTC, a location indication for the origin device 405-b (e.g., origin_geo, mapped city code), an IP address indication (e.g., origin_network), the identifier for the origin device 405-b, an agent associated with the origin device 405-b (e.g., origin_userAgent), one or more time stamps or time indications for the session (e.g., CreatedAt, UpdatedAt), the wallet address for the user, information associated with the target device 405-a, or any combination thereof. The information associated with the target device 405-a may include a location indication (e.g., target_geo, mapped city code), an IP address indication (e.g., target_network), the identifier for the target device 405-a, the agent associated with the target device 405-a (e.g., target_userAgent).

In some implementations, at 475, the SCW manager service 407 may update the session based on receiving the encrypted credential ID at 470. For example, the SCW manager service 407 may update the previous session by updating the state to attested (e.g., based on requiresExtraOTC being False).

At 480, the SCW manager service 407 may transmit the encrypted credential ID to the origin device 405-b. That is, the origin device 405-b may receive signaling (e.g., second signaling) that may include the encrypted credential ID associated with a new passkey for the blockchain wallet, where the new passkey may be associated with the target device 405-a and where the encrypted credential identifier may be encrypted based on the random secret. For example, the origin device 405-b may receive a response to the long poll initiated with the API call to get the session at 455. The response may include the public key associated with the new passkey and the credential ID encrypted with the random secret. In some examples, the public key may also be encrypted using the random secret. In some cases, the response to the API call to get the session may include the public key associated with the new passkey, the encrypted credential ID for the new passkey, the AAGUID for the new passkey, the indication of if the new passkey may be eligible to be backed up (e.g., passkeyIsBackupEligible), the session ID, an indication of the state of the session (e.g., attested), a location indication (e.g., target_geo, mapped city code), an IP address indication (e.g., target_network), the identifier for the target device 405-a, an agent associated with the target device 405-a (e.g., target_userAgent), information about the origin device 405-b, one or more time stamps or time indications (e.g., CreatedAt, UpdatedAt), or any combination thereof. In some examples, the information about the origin device 405-b may include a location indication (e.g., origin_geo, mapped city code), an IP address indication (e.g., origin_network), the identifier for the origin device 405-b, an agent associated with the origin device 405-b (e.g., origin_userAgent), the smart wallet address for the user (e.g., baseContractAddress), or any combination thereof. In some cases, receiving the encrypted credential ID at the origin device 405-b may be indicative of a confirmation of an identity of the origin device 405-b based on the identifier for the origin device 405-b.

At 485, the origin device 405-b may sign a transaction (e.g., blockchain transaction) that may add the new passkey as an owner of the wallet. For example, the origin device 405-b may display a user interface confirming the addition of the public key and associated credential ID to the list of owners for the wallet. In some cases, the user interface may confirm the identity of the target device 405-a (e.g., target_context) via the user interface. For example, the wallet application at the origin device 405-b may present the user with a transaction that may add the owner (e.g., public key) to the smart contract for the wallet (e.g., via AddOwner). The user may approve and sign the transaction, and a front end associated with the origin device 405-b may send the API call to update the signers (e.g., updateSigners). The API call to update the signers may include the wallet address for the user, the new signers (e.g., addSigners), a network identifier (e.g., initialNetworkID), a signature (e.g., signedUserOp), a unique API identifier (e.g., Nonce), or any combination thereof. The response to the API call to update the signers may include an indication of the SCW account (e.g., SCWAccount).

In some implementations, after the origin device 405-b may sign the transaction and update the signers, the origin device 405-b may transmit an API call to confirm the import session, which may include the session ID and the identifier for the origin device 405-b. A response to the API call to confirm the import session may include the session ID, an indication of a state (e.g., confirmed), the OTC, a location indication (e.g., target_geo, mapped city code), an IP address indication (e.g., target_network), the identifier for the target device 405-a, an agent associated with the target device 305-a (e.g., target_userAgent), information about the origin device 405-b, one or more time stamps or time indications (e.g., CreatedAt, UpdatedAt), or any combination thereof. In some examples, the information about the origin device 405-b may include a location indication (e.g., origin_geo, mapped city code), an IP address indication (e.g., origin_network), the identifier for the origin device 405-b, an agent associated with the origin device 405-b (e.g., origin_userAgent), the wallet address for the user (e.g., baseContractAddress), or any combination thereof. In some cases, the origin device 405-b may display an indication that the new passkey may have been successfully added as an owner for the wallet.

After the origin device 405-b may sign the transaction, the target device 405-a may access the blockchain wallet using the new passkey in accordance with transmitting the second signaling, as described at 470. In some cases, the target device 405-a may receive information indicative of the new passkey being added as owner of the blockchain wallet, where access of the blockchain wallet using the new passkey may be in accordance with the new passkey being added as owner of the blockchain wallet. For example, the target device 405-a may poll to get the import session and may wait to receive an indication that the state has been updated to confirmed. The poll may include the session ID and the identifier for the target device 405-a. The response may include the session ID, an indication of a state (e.g., confirmed), the OTC, the second OTC, a location indication (e.g., target_geo, mapped city code), an IP address indication (e.g., target_network), the identifier for the target device 405-a, the agent associated with the target device 405-a (e.g., target_userAgent), information about the origin device 405-b, one or more time stamps or time indications (e.g., CreatedAt, UpdatedAt), or any combination thereof. In some examples, the information about the origin device 405-b may include a location indication (e.g., origin_geo, mapped city code), an IP address indication (e.g., origin_network), the identifier for the origin device 405-b, an agent associated with the origin device 405-b (e.g., origin_userAgent), the wallet address for the user (e.g., baseContractAddress), or any combination thereof. After the state is returned as confirmed, the passkey may be associated with the wallet (e.g., SCWAccount), and may be used as a valid authentication token to sign the user in to the wallet via the target device 405-a.

FIG. 5 shows an example of a process flow 500 that supports cross device importing in accordance with aspects of the present disclosure. The process flow 500 may implement or be implemented to realize aspects of the computing environment 100, the signaling environment 200, and the process flows 300 and 400. For example, the process flow 500 may illustrate communication between devices 505-a and 505-b, which may be examples of corresponding devices described herein, including with reference to FIGS. 1-4. Process flow 500 may support a target device-initiated QR code protocol for adding a new passkey, associated with the target device 405-a, as an owner of a blockchain wallet.

In some implementations, devices 505 may communicate to generate and authorize a passkey to allow a target device 505-a to access a blockchain wallet, where the blockchain wallet may be accessible at an origin device 505-b using a device-based passkey. As described with reference to process flows 300 and 400, the devices 505 may use protocols, such as a 2×OTC protocol or a QR code protocol, to securely initiate the import session. Process flow 500 may be an example of a QR code procedure for performing cross device importing for a blockchain wallet between the target device 505-a, which may be an example of a desktop device, and the origin device 505-b, which may be an example of a mobile device.

In some implementations, a user may attempt to access the blockchain wallet via a wallet application on the target device 505-a (e.g., first device). The wallet application may prompt the user to scan a QR code at the target device 505-a using the origin device 505-b(e.g., second device), as described at 525.

In some implementations, at 510, the target device 505-a may generate a random secret. In some cases, the target device 505-a may also generate a session ID (e.g., session_id).

At 515, the target device 505-a (e.g., a second device) may transmit, to the SCW manager service 507, signaling (e.g., third signaling) that may include the session ID associated with a session (e.g., import session). For example, the target device 505-a may transmit an API call to create a session (e.g., createSession) to the SCW manager service 507. A payload of the API call may include the session ID. In some examples, the payload of the API call may also include an identifier for the target device 505-a (e.g., deviceName), and may indicate that the QR code protocol may be implemented, rather than the 2×OTC protocol (e.g., RequiresDoubleOTC may be false). In some cases, the target device 505-a may receive one or more API responses to the API call to create the session, which may include the session ID, an indication of a state for the session (e.g., pre-initialized), an OTC (e.g., a randomly generated 7 digit number), a location indication for the target device 505-a (e.g., target_geo, mapped city code), an IP address indication (e.g., target_network), the identifier for the target device 505-a, an agent associated with the target device 505-a (e.g., target_userAgent), one or more time stamps or time indications for the session (e.g., CreatedAt, UpdatedAt), or any combination thereof.

In some implementations, at 520, the SCW manager service 507 may store the session based on receiving the API call to create the session from the target device 505-a at 515. For example, the SCW manager service 507 may store the session ID and one or more associated parameters. In some examples, the SCW manager service 507 may store an indication of the QR code protocol (e.g., requiresExtraOTC may be False). Additionally, or alternatively, the SCW manager service 507 may store an indication of a status of the session, which may be pre-initialization (e.g., pre-init). Additionally, or alternatively, the SCW manager service 507 may store an indication that the random secret may not be signaled to or stored at the SCW manager service 507 (e.g., secret may be null). For example, the random secret may be shared directly between the origin device 505-b and the target device 505-a using a QR code, as described at 525, 530, and 535. This may increase security and reduce the risk of a “man-in-the-middle” attack during the signaling of an encrypted credential ID. In some cases, the SCW manager service 507 may transmit the response to the API call to create the session, as described at 515, based on storing the session at 520.

In some implementations, at 525, the target device 505-a may display an image that may include information that may encode the random secret and the session ID. For example, the target device 505-a may display a QR code that encodes the random secret and the session ID (or encodes a link to obtain such information).

At 530, the origin device 505-b may communicate, with the target device 405-a, signaling (e.g., first signaling) to initiate an import session for a blockchain wallet associated with a device-based passkey, where the signaling may include the random secret and where the device-based passkey may be associated with the origin device 505-b. In some implementations, at 430, the origin device 505-b may obtain, from an image sensor of the origin device 505-b, an imaging including information that encodes the random secret. For example, the origin device 505-b may scan the QR code, which may encode the random secret and which may result in the transfer of the random secret (e.g., QR code secret) from the target device 505-a to the origin device 505-b. In some cases, the device-based passkey associated with the origin device 505-b may include a passkey for the origin device 505-b, a cloud-based passkey associated with a first operating system for the origin device 505-b, or any combination thereof. In some cases, the first signaling may include the session ID. For example, the QR code may encode both the random secret and the session ID.

Process flow 500 may include operations at 535-585, which may mirror operations 435-485 of process flow 400. For example, the description of operations at 435-485, regarding process flow 400, may be applicable to operations at 535-585 of process flow 500.

For example, in some implementations, at 535, the target device 505-a may transmit an API call to get the session (e.g., getOTCSession), which may include the session ID. The API call to get the session may be a long poll, such that the target device 505-a may periodically poll the session until the target device 505-a may receive a response to the API call to get the session indicating that the state of the session is initialized.

In some implementations, at 540, the origin device 505-b may transmit, to the SCW manager service, an API call to create an OTC session (e.g., createOTCSession). For example, the target device 505-a may prompt a user to scan a QR code or to display an OTC code. The user may scan the QR code, as described at 530, which may prompt an API call to the SCW manager service 507 to initiate an OTC session. In some cases, the API call to create the OTC session at 540, or the API call to create the session at 515, may be an indication that the import session may be associated with the origin device 505-b.

In some implementations, at 545, the SCW manager service 507 may update the session based on receiving the API call to create the OTC session at 540. For example, the SCW manager service 507 may update the session such that the previous session (e.g., the session stored at 525) may be updated to include an OTC (e.g., otc1) and a state may be updated, such as to initialize (e.g., init). In some implementations, the updated state may prompt the SCW manager service 507 to transmit a response to the API call from the target device 505-a to get the session at 535.

In some implementations, the target device 505-a may further transmit an API call to claim the import session based on receiving the response, which may include the OTC, the identifier for the target device 505-a, and the address of the blockchain wallet for the user.

The SCW manager service 507 may update the session based on receiving the API call to claim the OTC session, such that the previous session (e.g., the session stored at 545) state may be updated to claimed. In some cases, the SCW manager service 507 may transmit a response to the API call to claim the import session.

In some implementations, at 550, the SCW manager service 507 may transmit an indication that the OTC or a second OTC may be unused to the origin device 505-b. For example, the SCW manager service 507 may transmit, in response to the API call to create the OTC session at 540, the OTC to the origin device 505-b, as well as an indication that the OTC may be unused based on one or more parameters for the QR code protocol (e.g., requiresExtraOTC is False).

In some implementations, at 555, the origin device 505-b may transmit an API call to get the session (e.g., getSession), which may include the session ID. The API call to get the session may be a long poll, which may allow the origin device 505-b to monitor for or wait for a response to the long poll, such as for a defined period of time, until the OTC session may be claimed by the target device 505-a.

In some implementations, at 560, the target device 505-a may receive an indication that the session may be associated with the origin device 505-b. In some cases, at 560, the indication that the import session may be associated with the origin device 505-b may include information associated with the origin device 505-b. For example, the target device 505-a may receive an indication of the identity of the origin device 505-b (e.g., origin_context). In some cases, the indication may be a response to the long poll to get the session at 540, or a response to the API call to claim the import session.

In some implementations, at 565, the target device 505-a may confirm the identity of the origin device 505-b. For example, the target device 505-a may display the identifier for the origin device 505-b and a user interface component associated with confirmation of the identifier for the origin device 505-b. The target device 505-a may receive user input selecting the user interface component, wherein the user input may confirm the identifier for the origin device 505-b.

In some implementations, the target device 505-a may generate, in accordance with confirming the identity of the origin device 505-b at 565, a new passkey associated with the target device 505-a, where the new passkey may allow access to the blockchain wallet. In some cases, the target device 505-a may encrypt a credential ID associated with the new passkey using the random secret. For example, the target device 505-a may display a user interface for the user to input the new passkey. The target device 505-a may determine a credential ID associated with the new passkey and may encrypt the credential ID using the random secret.

At 570, the target device 505-a may transmit second signaling including the encrypted credential ID associated with the new passkey for the blockchain wallet, where the encrypted credential ID may be encrypted based on the random secret. For example, based on receiving the user input at 565, the target device 505-a may transmit an indication of an encrypted credential ID for the new passkey for the blockchain wallet to the SCW manager service 507. In some cases, the second signaling may include an API call to attest the session based on verifying the identity of the origin device 505-b.

In some implementations, at 575, the SCW manager service 507 may update the session based on receiving the encrypted credential ID at 570. For example, the SCW manager service 507 may update the previous session by updating the state to attested (e.g., based on requiresExtraOTC being False).

At 580, the SCW manager service 507 may transmit the encrypted credential ID to the origin device 505-b. That is, the origin device 505-b may receive signaling (e.g., second signaling) that may include the encrypted credential ID associated with a new passkey for the blockchain wallet, where the new passkey may be associated with the target device 505-a and where the encrypted credential identifier may be encrypted based on the random secret. For example, the origin device 505-b may receive a response to the long poll initiated with the API call to get the session at 555. The response may include the public key associated with the new passkey and the credential ID encrypted with the random secret. In some examples, the public key may also be encrypted using the random secret.

At 585, the origin device 505-b may sign a transaction (e.g., blockchain transaction) that may add the new passkey as an owner of the wallet. For example, the origin device 505-b may display a user interface confirming the addition of the public key and associated credential ID to the list of owners for the wallet. In some cases, the user interface may confirm the identity of the target device 505-a (e.g., target_context) via the user interface. For example, the wallet application at the origin device 505-b may present the user with a transaction that may add the owner (e.g., public key) to the smart contract for the wallet (e.g., via AddOwner). The user may approve and sign the transaction, and a front end associated with the origin device 505-b may send the API call to update the signers (e.g., updateSigners).

In some implementations, after the origin device 505-b may sign the transaction and update the signers, the origin device 505-b may transmit an API call to confirm the import session, which may include the session ID and the identifier for the origin device 505-b. In some cases, the origin device 505-b may display an indication that the new passkey may have been successfully added as an owner for the wallet.

After the origin device 505-b may sign the transaction, the target device 505-a may access the blockchain wallet using the new passkey in accordance with transmitting the second signaling, as described at 570. In some cases, the target device 505-a may receive information indicative of the new passkey being added as owner of the blockchain wallet, where access of the blockchain wallet using the new passkey may be in accordance with the new passkey being added as owner of the blockchain wallet. For example, the target device 505-a may poll to get the import session and may wait to receive an indication that the state has been updated to confirmed. After the state is returned as confirmed, the passkey may be associated with the wallet (e.g., SCWAccount), and may be used as a valid authentication token to sign the user into the wallet via the target device 505-a.

In some implementations, the cross device import of the blockchain wallet may be facilitated by an application entry point (e.g., walletlink). For example, in addition to the operations illustrated in process flow 500, an additional API call to create a session endpoint at the application, including the session ID, may be transmitted from the target device 505-a to the application. In some cases, after scanning the QR code at the target device 505-a, the origin device 505-b may transmit an API call to get the session, as at 540 (e.g., for some version of the application). In other cases, the origin device 505-b may join the session at the application, which may facilitate the generation and authorization of the new passkey to access the blockchain wallet.

FIG. 6 shows an example of a process flow 600 that supports cross device importing in accordance with aspects of the present disclosure. The process flow 500 may implement or be implemented to realize aspects of the computing environment 100, the signaling environment 200, and the process flows 300, 400, and 500. For example, the process flow 600 may illustrate communication between devices 605-a and 605-b, which may be examples of corresponding devices described herein, including with reference to FIGS. 1-5. Process flow 600 may support an origin device 605-b to cancel a cross device import session using a QR code protocol.

In some implementations, a target device 605-a and an origin device 605-b may communicate to add a passkey associated with the target device 605-a as an owner for a wallet (e.g., blockchain wallet), accessible at the origin device 605-b using a device-based passkey. The target device 605-a and the origin device 605-b may communicate via secure sessions, which may be initiated using a 2×OTC protocol, as in process flow 300, or a QR code protocol, as in process flows 400 and 500.

In some implementations, the target device 605-a and the origin device 605-b may begin to communicate via the session (e.g., import session), and the origin device 605-b or the target device 605-a may revoke or end the session. The target device 605-a may return to the beginning of a process flow, such as the process flows 300, 400, or 500, and may determine whether to begin a new session to perform the blockchain wallet import using a 2×OTC protocol or a QR code protocol. For example, the target device 605-a may receive signaling (e.g., third signaling) to initiate an import session (e.g., second import session) for a blockchain wallet associated with a device-based passkey. The signaling may include a random secret. The target device 605-a may receive an indication (e.g., second indication) that the import session is canceled (e.g., revoked), where reception of the second indication may prompt the target device 605-a to restart the import session and receive new signaling to initiate another import session for the blockchain wallet (e.g., the target device 605-a may restart the blockchain wallet import process).

For example, in process flow 600, the target device 605-a may establish an import session with the origin device 605-b using a QR code (e.g., 610-635), as described with reference to process flow 400 (e.g., 410-435). However, at 640, the origin device 605-b may transmit an API call to cancel or revoke the import session (e.g., revokeSession).

For example, at 610, the origin device 605-b may generate a random secret. In some cases, the origin device 605-b may also generate a session ID (e.g., session_id).

At 615, the origin device 605-b (e.g., a second device) may transmit, to the SCW manager service 607, signaling (e.g., third signaling) that may include a session ID associated with an import session. For example, the origin device 605-b may transmit an API call to create a session (e.g., import session) (e.g., createSession) to the SCW manager service 607.

At 620, the SCW manager service 607 may store the session based on receiving the API call to create the session from the origin device 605-b at 615. For example, the SCW manager service 607 may store the session ID and one or more associated parameters. For example, the SCW manager service 607 may store an indication of the QR code protocol (e.g., requiresExtraOTC may be False). Additionally, or alternatively, the SCW manager service 607 may store an indication of a status of the session, which may be pre-initialization (e.g., pre-init). Additionally, or alternatively, the SCW manager service 607 may store an indication that the random secret may not be signaled to or stored at the SCW manager service 607 (e.g., secret may be null). For example, the random secret may be shared directly between the origin device 605-b and the target device 605-a using a QR code, as described at 625, 630, and 635. In some cases, the SCW manager service 607 may transmit the response to the API call to create the session, as described at 615, based on storing the session at 620.

At 625, the origin device 605-b may display an image that may include information that may encode the random secret and the session ID. For example, the origin device 605-b may display a QR code.

At 630, the origin device 605-b may communicate, with the target device 605-a, signaling (e.g., first signaling) to initiate an import session for the wallet associated with a device-based passkey, where the signaling may include the random secret and where the device-based passkey may be associated with the origin device 605-b (e.g., second device). In some cases, the target device 605-a may obtain, from an image sensor of the target device 605-a, an imaging including information that encodes the random secret. For example, the target device 605-a may scan a QR code that encodes the random secret, which may result in the transfer of the random secret (e.g., QR code secret) from the origin device 605-b to the target device 605-a. In some cases, the signaling may include the session ID. For example, the QR code may encode both the random secret and the session ID.

In some implementations, at 635, the target device 605-a may transmit an API call to get the session (e.g., getOTCSession), which may include the session ID. The API call to get the session may be a long poll, such that the target device 605-a may periodically poll the session until the target device 605-a may receive a response to the API call to get the session indicating that the state of the session is initialized.

At 640, the origin device 605-b may transmit an API call to cancel or revoke the import session (e.g., revokeSession).

At 645, the SCW manager service 607 may update the session to indicate the state of the session as revoked.

At 650 and in response to the API call to get the session at 635, the SCW manager service 607 may transmit an indication to the target device 605-a that the session has been revoked (e.g., long poll, state is revoked).

At 655, the target device 605-a may determine or choose whether to restart the import session, and whether to use the QR code protocol or 2×OTC protocol. In some cases, the target device 605-a may restart the import session using the 2×OTC protocol, as in process flow 300. In other cases, the target device 605-a may restart the import session using the QR code protocol, as described in process flows 400 and 500.

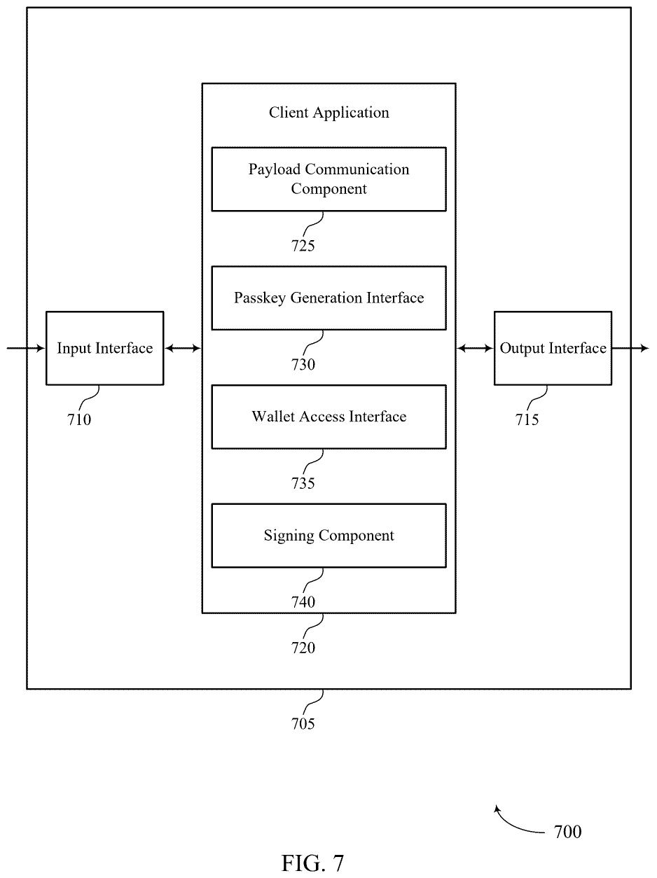

FIG. 7 shows a block diagram 700 of a device 705 that supports cross device importing in accordance with aspects of the present disclosure. The device 705 may include an input interface 710, an output interface 715, and a client application 720. The device 705, or one or more components of the device 705 (e.g., the input interface 710, the output interface 715, the client application 720), may include at least one processor, which may be coupled with at least one memory, to support the described techniques. Each of these components may be in communication with one another (e.g., via one or more buses).

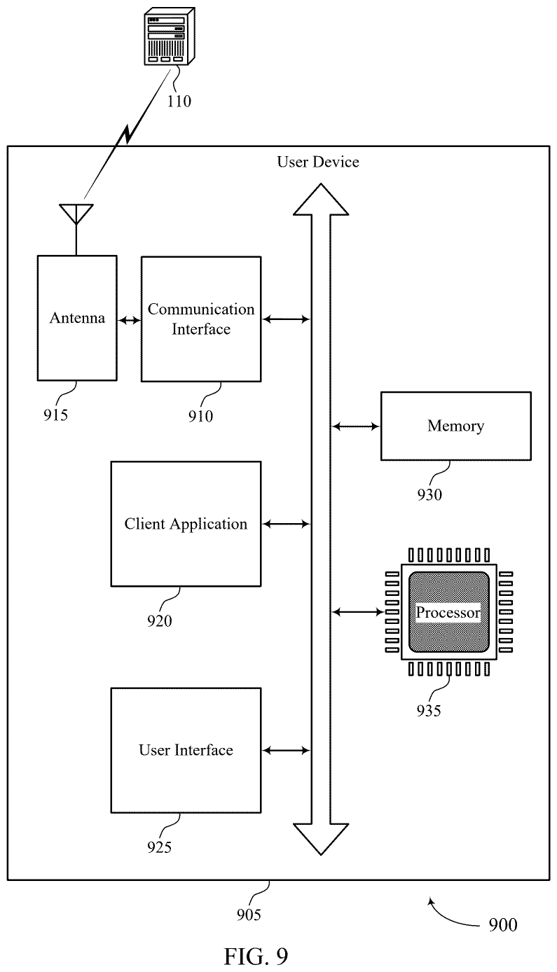

The input interface 710 may manage input signaling for the user device 705. For example, the input interface 710 may receive input signaling (e.g., messages, packets, data, instructions, commands, transactions, or any other form of encoded information) from other systems or devices. The input interface 710 may send signaling corresponding to (e.g., representative of or otherwise based on) such input signaling to other components of the user device 705 for processing. For example, the input interface 710 may transmit such corresponding signaling to the client application 720 to support cross device importing. In some cases, the input interface 710 may be a component of a communication interface 910 as described with reference to FIG. 9.

The output interface 715 may manage output signaling for the device 705. For example, the output interface 715 may receive signaling from other components of the device 705, such as the client application 720, and may transmit such output signaling corresponding to (e.g., representative of or otherwise based on) such signaling to other systems or devices. In some cases, the output interface 715 may be a component of a communication interface 910 as described with reference to FIG. 9.

For example, the client application 720 may include a payload communication component 725, a passkey generation interface 730, a wallet access interface 735, a signing component 740, or any combination thereof. In some examples, the client application 720, or various components thereof, may be configured to perform various operations (e.g., receiving, monitoring, transmitting) using or otherwise in cooperation with the input interface 710, the output interface 715, or both. For example, the client application 720 may receive information from the input interface 710, send information to the output interface 715, or be integrated in combination with the input interface 710, the output interface 715, or both to receive information, transmit information, or perform various other operations as described herein.

The payload communication component 725 may be configured as or otherwise support a means for communicating first signaling to initiate an import session for a blockchain wallet associated with a device-based passkey, wherein the first signaling comprises a random secret and wherein the device-based passkey is associated with a second device. The payload communication component 725 may be configured as or otherwise support a means for receiving an indication that the import session is associated with the second device. The passkey generation interface 730 may be configured as or otherwise support a means for generating, in accordance with receiving the indication, a new passkey associated with the first device, wherein the new passkey allows access to the blockchain wallet. The payload communication component 725 may be configured as or otherwise support a means for transmitting second signaling comprising an encrypted credential ID associated with the new passkey, wherein the encrypted credential ID is encrypted based at least in part on the random secret. The wallet access interface 735 may be configured as or otherwise support a means for accessing the blockchain wallet using the new passkey in accordance with transmitting the second signaling.

The payload communication component 725 may be configured as or otherwise support a means for communicating first signaling that initiates an import session for a blockchain wallet associated with a device-based passkey, wherein the first signaling comprises a random secret, and wherein the device-based passkey is associated with the second device. The payload communication component 725 may be configured as or otherwise support a means for transmitting an indication that the import session is associated with the second device. The payload communication component 725 may be configured as or otherwise support a means for receiving second signaling comprising an encrypted credential ID associated with a new passkey for the blockchain wallet, wherein the new passkey is associated with a first device and wherein the encrypted credential ID is encrypted based at least in part on the random secret. The signing component 740 may be configured as or otherwise support a means for signing a blockchain transaction authorizing access to the blockchain wallet using the new passkey, wherein authorizing access is based at least in part on the device-based passkey.

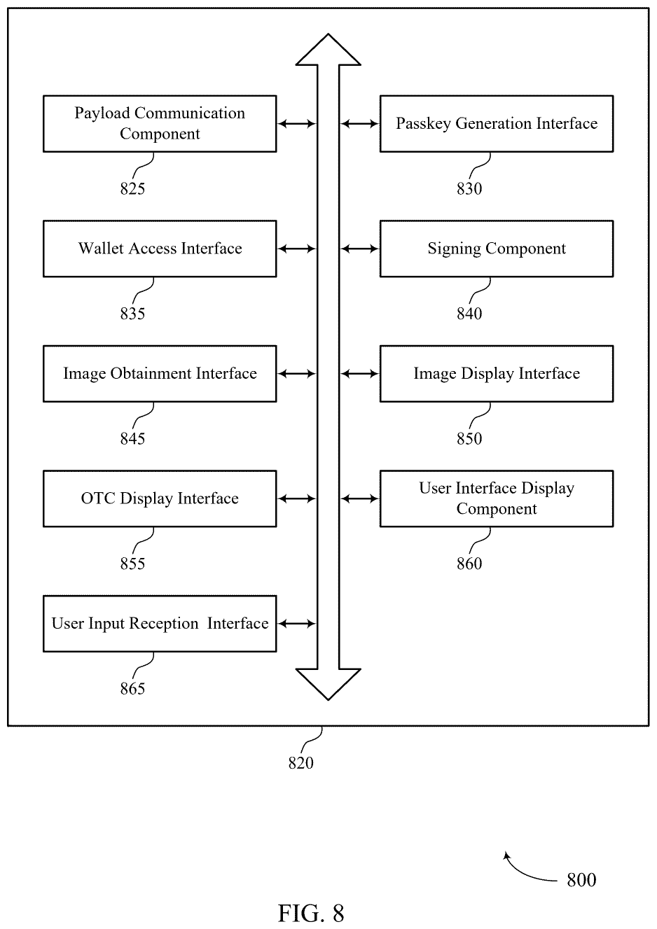

FIG. 8 shows a block diagram 800 of a client application 820 that supports cross device importing in accordance with aspects of the present disclosure. The client application 820 may be an example of aspects of a client application or a client application 720, or both, as described herein. The client application 820, or various components thereof, may be an example of means for performing (e.g., to cause the client application 820 to perform) various aspects of cross device importing as described herein. For example, the client application 820 may include a payload communication component 825, a passkey generation interface 830, a wallet access interface 835, a signing component 840, an image obtainment interface 845, an image display interface 850, an OTC display interface 855, a user interface display component 860, a user input reception interface 865, or any combination thereof. Each of these components, or components of subcomponents thereof (e.g., one or more processors, one or more memories), may communicate, directly or indirectly, with one another (e.g., via one or more buses).

The payload communication component 825 may be configured as or otherwise support a means for communicating first signaling to initiate an import session for a blockchain wallet associated with a device-based passkey, wherein the first signaling comprises a random secret and wherein the device-based passkey is associated with a second device. In some examples, the payload communication component 825 may be configured as or otherwise support a means for receiving an indication that the import session is associated with the second device. The passkey generation interface 830 may be configured as or otherwise support a means for generating, in accordance with receiving the indication, a new passkey associated with the first device, wherein the new passkey allows access to the blockchain wallet. In some examples, the payload communication component 825 may be configured as or otherwise support a means for transmitting second signaling comprising an encrypted credential ID associated with the new passkey, wherein the encrypted credential ID is encrypted based at least in part on the random secret. The wallet access interface 835 may be configured as or otherwise support a means for accessing the blockchain wallet using the new passkey in accordance with transmitting the second signaling.

In some examples, the payload communication component 825 may be configured as or otherwise support a means for receiving information indicative of the new passkey being added as owner of the blockchain wallet, wherein access of the blockchain wallet using the new passkey is in accordance with the new passkey being added as owner of the blockchain wallet.

In some examples, to support communicating the first signaling, the image obtainment interface 845 may be configured as or otherwise support a means for obtaining, from an image sensor of the first device, an image including information that encodes the random secret.

In some examples, to support communicating the first signaling, the payload communication component 825 may be configured as or otherwise support a means for transmitting, to a manager service, third signaling comprising a session ID associated with the import session. In some examples, to support communicating the first signaling, the image display interface 850 may be configured as or otherwise support a means for displaying an image including information that encodes the random secret and the session ID.

In some examples, to support communicating the first signaling, the OTC display interface 855 may be configured as or otherwise support a means for displaying, at the first device, a one-time code associated with initiation of the import session. In some examples, to support communicating the first signaling, the payload communication component 825 may be configured as or otherwise support a means for transmitting, to a manager service, the first signaling, wherein the first signaling creates the import session.

In some examples, to support receiving the indication that the import session is associated with the second device, the payload communication component 825 may be configured as or otherwise support a means for receiving an indication that the import session is claimed by the second device in accordance with displaying the one-time code.

In some examples, the user interface display component 860 may be configured as or otherwise support a means for displaying, at the first device, a user interface component for entering a second one-time code displayed by the second device. In some examples, the user input reception interface 865 may be configured as or otherwise support a means for receiving user input comprising the second one-time code, wherein the user input confirms an identity of the second device and wherein the second signaling comprising the new passkey is transmitted after receiving the user input.

In some examples, the indication that the import session is associated with the second device comprises an identifier for the second device.

In some examples, the user interface display component 860 may be configured as or otherwise support a means for displaying, at the first device, the identifier for the second device and a user interface component associated with confirmation of the identifier for the second device. In some examples, the user input reception interface 865 may be configured as or otherwise support a means for receiving user input selecting the user interface component, wherein the user input confirms the identifier for the second device and wherein the second signaling comprising the new passkey is transmitted after receiving the user input.

In some examples, the payload communication component 825 may be configured as or otherwise support a means for receiving third signaling to initiate a second import session for the blockchain wallet associated with the device-based passkey, wherein the third signaling comprises a second random secret. In some examples, the payload communication component 825 may be configured as or otherwise support a means for receiving a second indication that the import session is canceled, wherein communication of the first signaling is based at least in part on reception of the second indication.

In some examples, the device-based passkey associated with the second device comprises a passkey for the second device, a cloud-based passkey associated with a first operating system for the second device, or any combination thereof.

In some examples, the new passkey comprises a second device-based passkey associated with the first device. In some examples, the second device-based passkey comprises a passkey for the first device, a cloud-based passkey associated with a second operating system for the first device, the second operating system different from the first operating system, or any combination thereof.

In some examples, the first signaling further comprises a session ID. In some examples, reception of the indication and transmission of the second signaling is in accordance with the session ID.

In some examples, the payload communication component 825 may be configured as or otherwise support a means for communicating first signaling that initiates an import session for a blockchain wallet associated with a device-based passkey, wherein the first signaling comprises a random secret, and wherein the device-based passkey is associated with the second device. In some examples, the payload communication component 825 may be configured as or otherwise support a means for transmitting an indication that the import session is associated with the second device. In some examples, the payload communication component 825 may be configured as or otherwise support a means for receiving second signaling comprising an encrypted credential ID associated with a new passkey for the blockchain wallet, wherein the new passkey is associated with a first device and wherein the encrypted credential ID is encrypted based at least in part on the random secret. The signing component 840 may be configured as or otherwise support a means for signing a blockchain transaction authorizing access to the blockchain wallet using the new passkey, wherein authorizing access is based at least in part on the device-based passkey.

In some examples, the payload communication component 825 may be configured as or otherwise support a means for transmitting information indicative of the new passkey being authorized to access the blockchain wallet, wherein the blockchain transaction authorizing access to the blockchain wallet comprises adding the new passkey as owner of the blockchain wallet.

In some examples, to support communicating the first signaling, the image obtainment interface 845 may be configured as or otherwise support a means for obtaining, from an image sensor of the first device, an image including information that encodes the random secret.

In some examples, to support communicating the first signaling, the payload communication component 825 may be configured as or otherwise support a means for transmitting, to a manager service, third signaling comprising a session ID associated with the import session. In some examples, to support communicating the first signaling, the image display interface 850 may be configured as or otherwise support a means for displaying an image including information that encodes the random secret and the session ID.

In some examples, to support communicating the first signaling, the user interface display component 860 may be configured as or otherwise support a means for displaying, at the second device, a user interface component for entering a one-time code displayed by the first device. In some examples, to support communicating the first signaling, the user input reception interface 865 may be configured as or otherwise support a means for receiving user input comprising the one-time code, wherein the first signaling comprising the new passkey is transmitted after receiving the user input.

In some examples, to support transmitting the indication that the import session is associated with the second device, the payload communication component 825 may be configured as or otherwise support a means for transmitting the indication that the import session is claimed by the second device in accordance with reception of the user input.

In some examples, the OTC display interface 855 may be configured as or otherwise support a means for displaying, at the first device, a second one-time code, wherein reception of the second signaling comprising the new passkey is based at least in part on displaying the second one-time code.

In some examples, the indication that the import session is associated with the second device comprises an identifier for the second device.

In some examples, receiving the second signaling is indicative of a confirmation of an identity of the second device based at least in part on the identifier for the second device.

In some examples, the payload communication component 825 may be configured as or otherwise support a means for transmitting third signaling to initiate a second import session for the blockchain wallet associated with the device-based passkey, wherein the third signaling comprises a second random secret. In some examples, the payload communication component 825 may be configured as or otherwise support a means for transmitting a second indication that the import session is canceled, wherein communicating the first signaling is based at least in part on transmission of the second indication.

In some examples, the new passkey is a device-based passkey associated with the first device, the new passkey is a cloud-based passkey associated with an operating system, or any combination thereof.

In some examples, the device-based passkey associated with the second device comprises a passkey for the second device, a passkey associated with a first operating system for the second device, or any combination thereof.

In some examples, the new passkey comprises a second device-based passkey associated with the first device. In some examples, the second device-based passkey comprises a passkey for the first device, a passkey associated with a second operating system for the first device, the second operating system different from the first operating system, or any combination thereof.

In some examples, the first signaling further comprises a session ID. In some examples, transmission of the indication and reception of the second signaling is in accordance with the session ID.

FIG. 9 shows a diagram of a system 900 including a device 905 that supports cross device importing in accordance with aspects of the present disclosure. The device 905 may be an example of or include components of a device 705 as described herein. The device 905 may include components for bi-directional voice and data communications including components for transmitting and receiving communications, such as a client application 920, a communication interface 910, one or more antennas 915, a user interface component 925, at least one memory 930, and at least one processor 935. Each of these components, or components of subcomponents thereof (e.g., one or more processors, one or more memories), may communicate, directly or indirectly, with one another (e.g., via one or more buses).

The communication interface 910 may manage input and output signals for the device 905 via the antenna 915. For example, the communication interface 910 may enable the user device 905 to exchange information (e.g., input information, output information, or both) with other systems or devices, such as custodial token platform 110 (e.g., supported by one or more servers), via one or more wired or wireless communication links. The communication interface 910 may also utilize or interact with antenna 915 to support communication with other systems or devices. In some cases, the communication interface 910 may represent a physical connection or port to an external peripheral, such as a hardware wallet device. In some cases, the communication interface 910 may utilize an operating system such as iOS®, ANDROID®, MS-DOS®, MS-WINDOWS®, OS/2®, UNIX®, LINUX®, or another known operating system. The communication interface 910 may be implemented as part of the processor 935.

In some cases, the device 905 may include a single antenna 915. However, in some other cases, the device 905 may have more than one antenna 915, which may be capable of concurrently transmitting or receiving multiple wireless transmissions. The communication interface 910 may communicate bi-directionally, via the one or more antennas 915, wired, or wireless links as described herein. For example, the communication interface 910 may represent a wireless transceiver and may communicate bi-directionally with another wireless transceiver. The communication interface 910 may also include a modem to modulate the packets, to provide the modulated packets to one or more antennas 915 for transmission, and to demodulate packets received from the one or more antennas 915.

The user interface component 925 may represent a keyboard, a mouse, a touchscreen, a microphone, or a similar device or component. In some cases, a user may interact with the user interface component 925. In other cases, the user interface component 925 may operate automatically without user interaction. The user interface component 925 may display or output information such as information received from other systems or devices or information to be transmitted to other systems or devices.

The memory 930 may include RAM and ROM. The memory 930 may store computer-readable, computer-executable software including instructions that, when executed, cause at least one processor 935 to perform various functions described herein. In some cases, the memory 930 may contain, among other things, a BIOS which may control basic hardware or software operation such as the interaction with peripheral components or devices. The memory 930 may be an example of a single memory or multiple memories. For example, the user device 905 may include one or more memories 930.

The processor 935 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 935 may be configured to operate a memory array using a memory controller. In other cases, a memory controller may be integrated into the processor 935. The processor 935 may be configured to execute computer-readable instructions stored in at least one memory 930 to perform various functions (e.g., functions or tasks supporting a method and system for cross device importing). Though a single processor 935 is depicted in the example of FIG. 9, it is to be understood that the user device 905 may include any quantity of one or more of processors 935 and that a group of processors 935 may collectively perform one or more functions ascribed herein to a processor, such as the processor 935. The processor 935 may be an example of a single processor or multiple processors. For example, the device 905 may include one or more processors 935.

For example, the client application 920 may be configured as or otherwise support a means for communicating first signaling to initiate an import session for a blockchain wallet associated with a device-based passkey, wherein the first signaling comprises a random secret and wherein the device-based passkey is associated with a second device. The client application 920 may be configured as or otherwise support a means for receiving an indication that the import session is associated with the second device. The client application 920 may be configured as or otherwise support a means for generating, in accordance with receiving the indication, a new passkey associated with the first device, wherein the new passkey allows access to the blockchain wallet. The client application 920 may be configured as or otherwise support a means for transmitting second signaling comprising an encrypted credential ID associated with the new passkey, wherein the encrypted credential ID is encrypted based at least in part on the random secret. The client application 920 may be configured as or otherwise support a means for accessing the blockchain wallet using the new passkey in accordance with transmitting the second signaling.

For example, the client application 920 may be configured as or otherwise support a means for communicating first signaling that initiates an import session for a blockchain wallet associated with a device-based passkey, wherein the first signaling comprises a random secret, and wherein the device-based passkey is associated with the second device. The client application 920 may be configured as or otherwise support a means for transmitting an indication that the import session is associated with the second device. The client application 920 may be configured as or otherwise support a means for receiving second signaling comprising an encrypted credential ID associated with a new passkey for the blockchain wallet, wherein the new passkey is associated with a first device and wherein the encrypted credential ID is encrypted based at least in part on the random secret. The client application 920 may be configured as or otherwise support a means for signing a blockchain transaction authorizing access to the blockchain wallet using the new passkey, wherein authorizing access is based at least in part on the device-based passkey.

By including or configuring the client application 920 in accordance with examples as described herein, the device 905 may support techniques for secure passkey generation and blockchain wallet import on new devices, improved user experience due to improved methods for blockchain wallet access and import, and improved coordination between devices.

The client application 920 may include an application (e.g., “app”), program, software, extension, or other component which is configured to facilitate communications with a custodial token platform 110 on a server, one or more nodes of a blockchain network 105, other user devices 905, and other devices or systems. For example, the client application 920 may be an application executable on the user device 905, and the client application 920 may be configured to receive data from a custodial token platform 110, transmit data to the custodial token platform 110, process such data, and cause presentation of such data to a user via a user interface component 925. The client application 920 may be an example of a wallet application, a wallet device, or both, and may be associated with a wallet address and may access or use a private key to sign messages to facilitate transfer of crypto tokens, messages, transactions, or the like via a blockchain distributed data store.

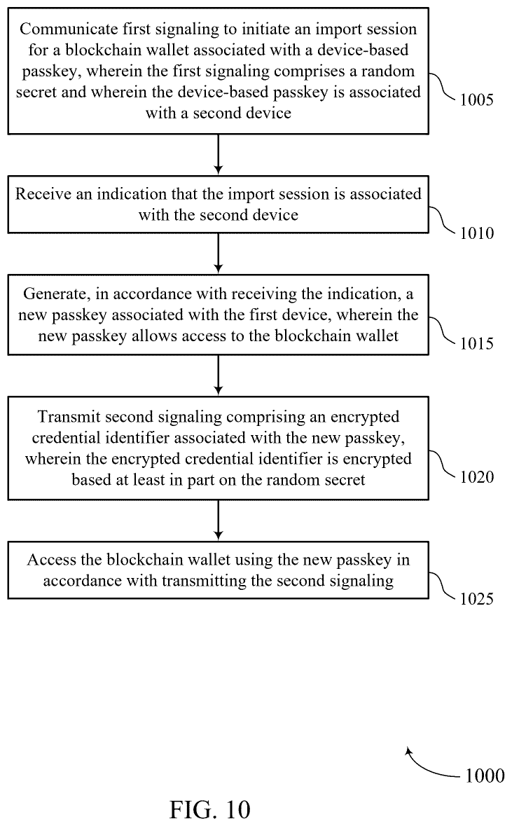

FIG. 10 shows a flowchart illustrating a method 1000 that supports cross device importing in accordance with aspects of the present disclosure. The operations of the method 1000 may be implemented by a user device or its components as described herein. For example, the operations of the method 1000 may be performed by a user device as described with reference to FIGS. 1 through 9. In some examples, a user device may execute a set of instructions to control the functional elements of the user device to perform the described functions. Additionally, or alternatively, the user device may perform aspects of the described functions using special-purpose hardware.

At 1005, the method may include communicating first signaling to initiate an import session for a blockchain wallet associated with a device-based passkey, wherein the first signaling comprises a random secret and wherein the device-based passkey is associated with a second device. The operations of 1005 may be performed in accordance with examples as disclosed herein. In some examples, aspects of the operations of 1005 may be performed by a payload communication component 825.

At 1010, the method may include receiving an indication that the import session is associated with the second device. The operations of 1010 may be performed in accordance with examples as disclosed herein. In some examples, aspects of the operations of 1010 may be performed by a payload communication component 825.

At 1015, the method may include generating, in accordance with receiving the indication, a new passkey associated with the first device, wherein the new passkey allows access to the blockchain wallet. The operations of 1015 may be performed in accordance with examples as disclosed herein. In some examples, aspects of the operations of 1015 may be performed by a passkey generation interface 830.

At 1020, the method may include transmitting second signaling comprising an encrypted credential ID associated with the new passkey, wherein the encrypted credential ID is encrypted based at least in part on the random secret. The operations of 1020 may be performed in accordance with examples as disclosed herein. In some examples, aspects of the operations of 1020 may be performed by a payload communication component 825.

At 1025, the method may include accessing the blockchain wallet using the new passkey in accordance with transmitting the second signaling. The operations of 1025 may be performed in accordance with examples as disclosed herein. In some examples, aspects of the operations of 1025 may be performed by a wallet access interface 835.

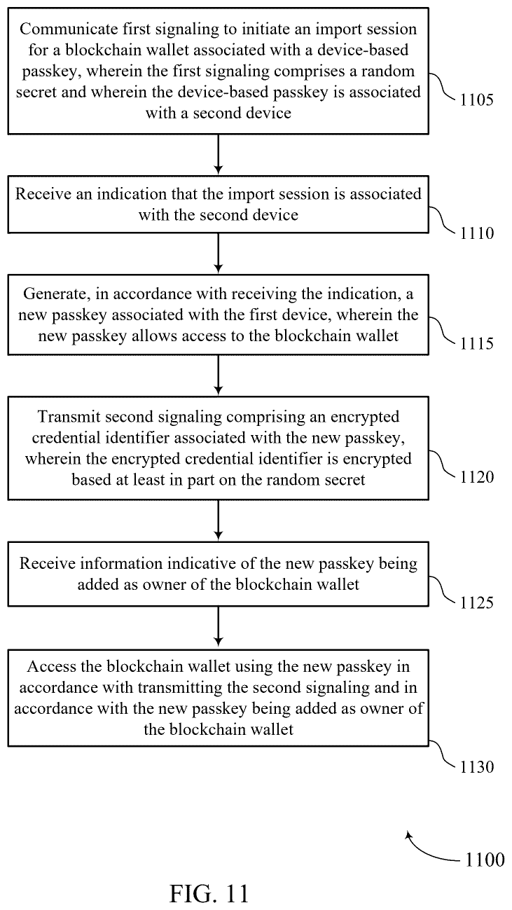

FIG. 11 shows a flowchart illustrating a method 1100 that supports cross device importing in accordance with aspects of the present disclosure. The operations of the method 1100 may be implemented by a user device or its components as described herein. For example, the operations of the method 1100 may be performed by a user device as described with reference to FIGS. 1 through 9. In some examples, a user device may execute a set of instructions to control the functional elements of the user device to perform the described functions. Additionally, or alternatively, the user device may perform aspects of the described functions using special-purpose hardware.

At 1105, the method may include communicating first signaling to initiate an import session for a blockchain wallet associated with a device-based passkey, wherein the first signaling comprises a random secret and wherein the device-based passkey is associated with a second device. The operations of 1105 may be performed in accordance with examples as disclosed herein. In some examples, aspects of the operations of 1105 may be performed by a payload communication component 825.

At 1110, the method may include receiving an indication that the import session is associated with the second device. The operations of 1110 may be performed in accordance with examples as disclosed herein. In some examples, aspects of the operations of 1110 may be performed by a payload communication component 825.

At 1115, the method may include generating, in accordance with receiving the indication, a new passkey associated with the first device, wherein the new passkey allows access to the blockchain wallet. The operations of 1115 may be performed in accordance with examples as disclosed herein. In some examples, aspects of the operations of 1115 may be performed by a passkey generation interface 830.

At 1120, the method may include transmitting second signaling comprising an encrypted credential ID associated with the new passkey, wherein the encrypted credential ID is encrypted based at least in part on the random secret. The operations of 1120 may be performed in accordance with examples as disclosed herein. In some examples, aspects of the operations of 1120 may be performed by a payload communication component 825.

At 1125, the method may include receiving information indicative of the new passkey being added as owner of the blockchain wallet, wherein access of the blockchain wallet using the new passkey is in accordance with the new passkey being added as owner of the blockchain wallet. The operations of 1125 may be performed in accordance with examples as disclosed herein. In some examples, aspects of the operations of 1125 may be performed by a payload communication component 825.

At 1130, the method may include accessing the blockchain wallet using the new passkey in accordance with transmitting the second signaling and in accordance with the new passkey being added as owner of the blockchain wallet. The operations of 1130 may be performed in accordance with examples as disclosed herein. In some examples, aspects of the operations of 1130 may be performed by a wallet access interface 835.

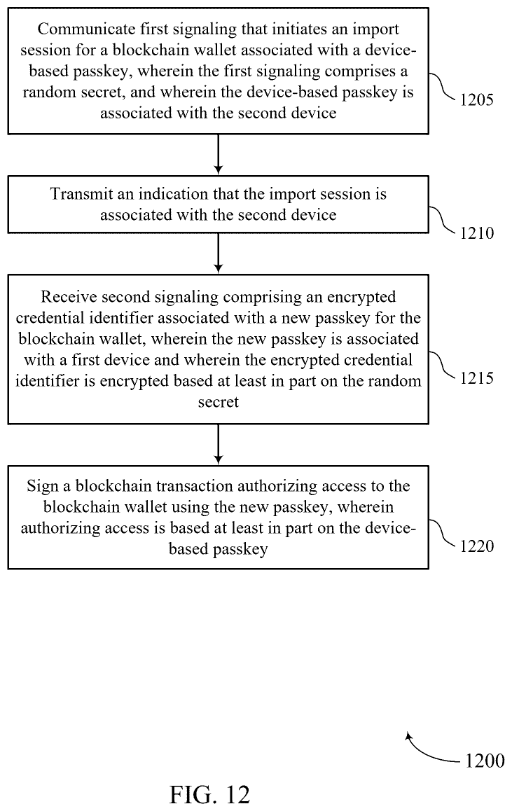

FIG. 12 shows a flowchart illustrating a method 1200 that supports cross device importing in accordance with aspects of the present disclosure. The operations of the method 1200 may be implemented by a user device or its components as described herein. For example, the operations of the method 1200 may be performed by a user device as described with reference to FIGS. 1 through 9. In some examples, a user device may execute a set of instructions to control the functional elements of the user device to perform the described functions. Additionally, or alternatively, the user device may perform aspects of the described functions using special-purpose hardware.

At 1205, the method may include communicating first signaling that initiates an import session for a blockchain wallet associated with a device-based passkey, wherein the first signaling comprises a random secret, and wherein the device-based passkey is associated with the second device. The operations of 1205 may be performed in accordance with examples as disclosed herein. In some examples, aspects of the operations of 1205 may be performed by a payload communication component 825.

At 1210, the method may include transmitting an indication that the import session is associated with the second device. The operations of 1210 may be performed in accordance with examples as disclosed herein. In some examples, aspects of the operations of 1210 may be performed by a payload communication component 825.

At 1215, the method may include receiving second signaling comprising an encrypted credential ID associated with a new passkey for the blockchain wallet, wherein the new passkey is associated with a first device and wherein the encrypted credential ID is encrypted based at least in part on the random secret. The operations of 1215 may be performed in accordance with examples as disclosed herein. In some examples, aspects of the operations of 1215 may be performed by a payload communication component 825.

At 1220, the method may include signing a blockchain transaction authorizing access to the blockchain wallet using the new passkey, wherein authorizing access is based at least in part on the device-based passkey. The operations of 1220 may be performed in accordance with examples as disclosed herein. In some examples, aspects of the operations of 1220 may be performed by a signing component 840.

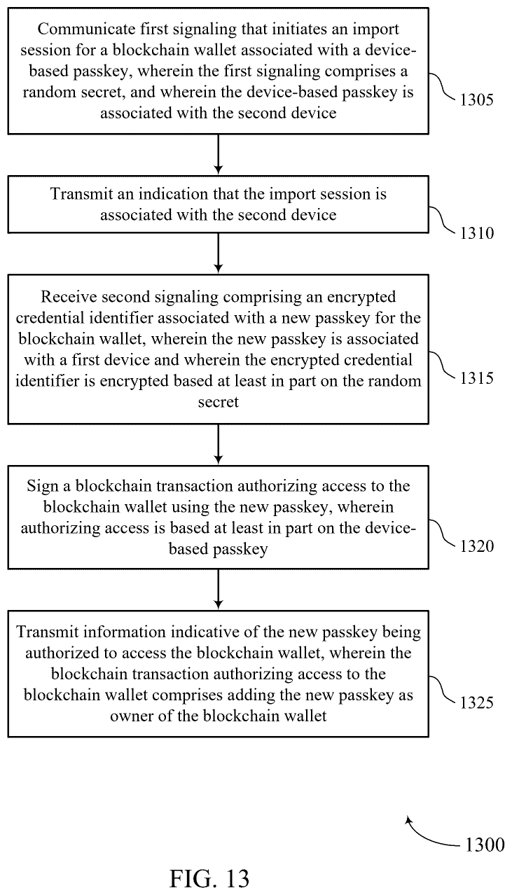

FIG. 13 shows a flowchart illustrating a method 1300 that supports cross device importing in accordance with aspects of the present disclosure. The operations of the method 1300 may be implemented by a user device or its components as described herein. For example, the operations of the method 1300 may be performed by a user device as described with reference to FIGS. 1 through 9. In some examples, a user device may execute a set of instructions to control the functional elements of the user device to perform the described functions. Additionally, or alternatively, the user device may perform aspects of the described functions using special-purpose hardware.

At 1305, the method may include communicating first signaling that initiates an import session for a blockchain wallet associated with a device-based passkey, wherein the first signaling comprises a random secret, and wherein the device-based passkey is associated with the second device. The operations of 1305 may be performed in accordance with examples as disclosed herein. In some examples, aspects of the operations of 1305 may be performed by a payload communication component 825.

At 1310, the method may include transmitting an indication that the import session is associated with the second device. The operations of 1310 may be performed in accordance with examples as disclosed herein. In some examples, aspects of the operations of 1310 may be performed by a payload communication component 825.

At 1315, the method may include receiving second signaling comprising an encrypted credential ID associated with a new passkey for the blockchain wallet, wherein the new passkey is associated with a first device and wherein the encrypted credential ID is encrypted based at least in part on the random secret. The operations of 1315 may be performed in accordance with examples as disclosed herein. In some examples, aspects of the operations of 1315 may be performed by a payload communication component 825.

At 1320, the method may include signing a blockchain transaction authorizing access to the blockchain wallet using the new passkey, wherein authorizing access is based at least in part on the device-based passkey. The operations of 1320 may be performed in accordance with examples as disclosed herein. In some examples, aspects of the operations of 1320 may be performed by a signing component 840.

At 1325, the method may include transmitting information indicative of the new passkey being authorized to access the blockchain wallet, wherein the blockchain transaction authorizing access to the blockchain wallet comprises adding the new passkey as owner of the blockchain wallet. The operations of 1325 may be performed in accordance with examples as disclosed herein. In some examples, aspects of the operations of 1325 may be performed by a payload communication component 825.

A method by a first device is described. The method may include communicating first signaling to initiate an import session for a blockchain wallet associated with a device-based passkey, wherein the first signaling comprises a random secret and wherein the device-based passkey is associated with a second device, receiving an indication that the import session is associated with the second device, generating, in accordance with receiving the indication, a new passkey associated with the first device, wherein the new passkey allows access to the blockchain wallet, transmitting second signaling comprising an encrypted credential ID associated with the new passkey, wherein the encrypted credential ID is encrypted based at least in part on the random secret, and accessing the blockchain wallet using the new passkey in accordance with transmitting the second signaling.

A first device is described. The first device may include one or more memories storing processor executable code, and one or more processors coupled with the one or more memories. The one or more processors may individually or collectively be operable to execute the code to cause the first device to communicate first signaling to initiate an import session for a blockchain wallet associated with a device-based passkey, wherein the first signaling comprises a random secret and wherein the device-based passkey is associated with a second device, receive an indication that the import session is associated with the second device, generate, in accordance with receiving the indication, a new passkey associated with the first device, wherein the new passkey allows access to the blockchain wallet, transmit second signaling comprising an encrypted credential ID associated with the new passkey, wherein the encrypted credential ID is encrypted based at least in part on the random secret, and access the blockchain wallet using the new passkey in accordance with transmitting the second signaling.

Another first device is described. The first device may include means for communicating first signaling to initiate an import session for a blockchain wallet associated with a device-based passkey, wherein the first signaling comprises a random secret and wherein the device-based passkey is associated with a second device, means for receiving an indication that the import session is associated with the second device, means for generating, in accordance with receiving the indication, a new passkey associated with the first device, wherein the new passkey allows access to the blockchain wallet, means for transmitting second signaling comprising an encrypted credential ID associated with the new passkey, wherein the encrypted credential ID is encrypted based at least in part on the random secret, and means for accessing the blockchain wallet using the new passkey in accordance with transmitting the second signaling.

A non-transitory computer-readable medium storing code is described. The code may include instructions executable by one or more processors to communicate first signaling to initiate an import session for a blockchain wallet associated with a device-based passkey, wherein the first signaling comprises a random secret and wherein the device-based passkey is associated with a second device, receive an indication that the import session is associated with the second device, generate, in accordance with receiving the indication, a new passkey associated with the first device, wherein the new passkey allows access to the blockchain wallet, transmit second signaling comprising an encrypted credential ID associated with the new passkey, wherein the encrypted credential ID is encrypted based at least in part on the random secret, and access the blockchain wallet using the new passkey in accordance with transmitting the second signaling.

Some examples of the method, first devices, and non-transitory computer-readable medium described herein may further include operations, features, means, or instructions for receiving information indicative of the new passkey being added as owner of the blockchain wallet, wherein access of the blockchain wallet using the new passkey may be in accordance with the new passkey being added as owner of the blockchain wallet.

In some examples of the method, first devices, and non-transitory computer-readable medium described herein, communicating the first signaling may include operations, features, means, or instructions for obtaining, from an image sensor of the first device, an image including information that encodes the random secret.

In some examples of the method, first devices, and non-transitory computer-readable medium described herein, communicating the first signaling may include operations, features, means, or instructions for transmitting, to a manager service, third signaling comprising a session ID associated with the import session and displaying an image including information that encodes the random secret and the session ID.

In some examples of the method, first devices, and non-transitory computer-readable medium described herein, communicating the first signaling may include operations, features, means, or instructions for displaying, at the first device, a one-time code associated with initiation of the import session and transmitting, to a manager service, the first signaling, wherein the first signaling creates the import session.

In some examples of the method, first devices, and non-transitory computer-readable medium described herein, receiving the indication that the import session may be associated with the second device may include operations, features, means, or instructions for receiving an indication that the import session may be claimed by the second device in accordance with displaying the one-time code.

Some examples of the method, first devices, and non-transitory computer-readable medium described herein may further include operations, features, means, or instructions for displaying, at the first device, a user interface component for entering a second one-time code displayed by the second device and receiving user input comprising the second one-time code, wherein the user input confirms an identity of the second device and wherein the second signaling comprising the new passkey may be transmitted after receiving the user input.

In some examples of the method, first devices, and non-transitory computer-readable medium described herein, the indication that the import session may be associated with the second device comprises an identifier for the second device.

Some examples of the method, first devices, and non-transitory computer-readable medium described herein may further include operations, features, means, or instructions for displaying, at the first device, the identifier for the second device and a user interface component associated with confirmation of the identifier for the second device and receiving user input selecting the user interface component, wherein the user input confirms the identifier for the second device and wherein the second signaling comprising the new passkey may be transmitted after receiving the user input.

Some examples of the method, first devices, and non-transitory computer-readable medium described herein may further include operations, features, means, or instructions for receiving third signaling to initiate a second import session for the blockchain wallet associated with the device-based passkey, wherein the third signaling comprises a second random secret and receiving a second indication that the import session may be canceled, wherein communication of the first signaling may be based at least in part on reception of the second indication.

In some examples of the method, first devices, and non-transitory computer-readable medium described herein, the device-based passkey associated with the second device comprises a passkey for the second device, a cloud-based passkey associated with a first operating system for the second device, or any combination thereof.

In some examples of the method, first devices, and non-transitory computer-readable medium described herein, the new passkey comprises a second device-based passkey associated with the first device and the second device-based passkey comprises a passkey for the first device, a cloud-based passkey associated with a second operating system for the first device, the second operating system different from the first operating system, or any combination thereof.

In some examples of the method, first devices, and non-transitory computer-readable medium described herein, the first signaling further comprises a session ID and reception of the indication and transmission of the second signaling may be in accordance with the session ID.

A method by a second device is described. The method may include communicating first signaling that initiates an import session for a blockchain wallet associated with a device-based passkey, wherein the first signaling comprises a random secret, and wherein the device-based passkey is associated with the second device, transmitting an indication that the import session is associated with the second device, receiving second signaling comprising an encrypted credential ID associated with a new passkey for the blockchain wallet, wherein the new passkey is associated with a first device and wherein the encrypted credential ID is encrypted based at least in part on the random secret, and signing a blockchain transaction authorizing access to the blockchain wallet using the new passkey, wherein authorizing access is based at least in part on the device-based passkey.

A second device is described. The second device may include one or more memories storing processor executable code, and one or more processors coupled with the one or more memories. The one or more processors may individually or collectively be operable to execute the code to cause the second device to communicate first signaling that initiates an import session for a blockchain wallet associated with a device-based passkey, wherein the first signaling comprises a random secret, and wherein the device-based passkey is associated with the second device, transmit an indication that the import session is associated with the second device, receive second signaling comprising an encrypted credential ID associated with a new passkey for the blockchain wallet, wherein the new passkey is associated with a first device and wherein the encrypted credential ID is encrypted based at least in part on the random secret, and sign a blockchain transaction authorizing access to the blockchain wallet using the new passkey, wherein authorizing access is based at least in part on the device-based passkey.

Another second device is described. The second device may include means for communicating first signaling that initiates an import session for a blockchain wallet associated with a device-based passkey, wherein the first signaling comprises a random secret, and wherein the device-based passkey is associated with the second device, means for transmitting an indication that the import session is associated with the second device, means for receiving second signaling comprising an encrypted credential ID associated with a new passkey for the blockchain wallet, wherein the new passkey is associated with a first device and wherein the encrypted credential ID is encrypted based at least in part on the random secret, and means for signing a blockchain transaction authorizing access to the blockchain wallet using the new passkey, wherein authorizing access is based at least in part on the device-based passkey.

A non-transitory computer-readable medium storing code is described. The code may include instructions executable by one or more processors to communicate first signaling that initiates an import session for a blockchain wallet associated with a device-based passkey, wherein the first signaling comprises a random secret, and wherein the device-based passkey is associated with the second device, transmit an indication that the import session is associated with the second device, receive second signaling comprising an encrypted credential ID associated with a new passkey for the blockchain wallet, wherein the new passkey is associated with a first device and wherein the encrypted credential ID is encrypted based at least in part on the random secret, and sign a blockchain transaction authorizing access to the blockchain wallet using the new passkey, wherein authorizing access is based at least in part on the device-based passkey.

Some examples of the method, second devices, and non-transitory computer-readable medium described herein may further include operations, features, means, or instructions for transmitting information indicative of the new passkey being authorized to access the blockchain wallet, wherein the blockchain transaction authorizing access to the blockchain wallet comprises adding the new passkey as owner of the blockchain wallet.

In some examples of the method, second devices, and non-transitory computer-readable medium described herein, communicating the first signaling may include operations, features, means, or instructions for obtaining, from an image sensor of the first device, an image including information that encodes the random secret.

In some examples of the method, second devices, and non-transitory computer-readable medium described herein, communicating the first signaling may include operations, features, means, or instructions for transmitting, to a manager service, third signaling comprising a session ID associated with the import session and displaying an image including information that encodes the random secret and the session ID.

In some examples of the method, second devices, and non-transitory computer-readable medium described herein, communicating the first signaling may include operations, features, means, or instructions for displaying, at the second device, a user interface component for entering a one-time code displayed by the first device and receiving user input comprising the one-time code, wherein the first signaling comprising the new passkey may be transmitted after receiving the user input.

In some examples of the method, second devices, and non-transitory computer-readable medium described herein, transmitting the indication that the import session may be associated with the second device may include operations, features, means, or instructions for transmitting the indication that the import session may be claimed by the second device in accordance with reception of the user input.

Some examples of the method, second devices, and non-transitory computer-readable medium described herein may further include operations, features, means, or instructions for displaying, at the first device, a second one-time code, wherein reception of the second signaling comprising the new passkey may be based at least in part on displaying the second one-time code.

In some examples of the method, second devices, and non-transitory computer-readable medium described herein, the indication that the import session may be associated with the second device comprises an identifier for the second device.

Some examples of the method, second devices, and non-transitory computer-readable medium described herein may further include operations, features, means, or instructions for receiving the second signaling may be indicative of a confirmation of an identity of the second device based at least in part on the identifier for the second device.

Some examples of the method, second devices, and non-transitory computer-readable medium described herein may further include operations, features, means, or instructions for transmitting third signaling to initiate a second import session for the blockchain wallet associated with the device-based passkey, wherein the third signaling comprises a second random secret and transmitting a second indication that the import session may be canceled, wherein communicating the first signaling may be based at least in part on transmission of the second indication.

In some examples of the method, second devices, and non-transitory computer-readable medium described herein, the new passkey may be a device-based passkey associated with the first device, the new passkey may be a cloud-based passkey associated with an operating system, or any combination thereof.

In some examples of the method, second devices, and non-transitory computer-readable medium described herein, the device-based passkey associated with the second device comprises a passkey for the second device, a passkey associated with a first operating system for the second device, or any combination thereof.

In some examples of the method, second devices, and non-transitory computer-readable medium described herein, the new passkey comprises a second device-based passkey associated with the first device and the second device-based passkey comprises a passkey for the first device, a passkey associated with a second operating system for the first device, the second operating system different from the first operating system, or any combination thereof.

In some examples of the method, second devices, and non-transitory computer-readable medium described herein, the first signaling further comprises a session ID and transmission of the indication and reception of the second signaling may be in accordance with the session ID.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method at a second device, comprising:
communicating first signaling that initiates an import session between a first device and the second device for a blockchain wallet associated with a device-based passkey, wherein the first signaling comprises a random secret, and wherein the device-based passkey is associated with the second device;
transmitting an indication that the import session is associated with the second device;
receiving second signaling comprising an encrypted credential identifier associated with a new passkey for the blockchain wallet, wherein the new passkey is associated with the first device and wherein the encrypted credential identifier is encrypted based at least in part on the random secret; and
signing a blockchain transaction authorizing access to the blockchain wallet using the new passkey, wherein authorizing access is based at least in part on the device-based passkey.

2. The method of claim 1, further comprising:
transmitting information indicative of the new passkey being authorized to access the blockchain wallet, wherein the blockchain transaction authorizing access to the blockchain wallet comprises adding the new passkey as owner of the blockchain wallet.

3. The method of claim 1, wherein communicating the first signaling comprises:
obtaining, from an image sensor of the first device, an image including information that encodes the random secret.

4. The method of claim 1, wherein communicating the first signaling comprises:
transmitting, to a manager service, third signaling comprising a session identifier associated with the import session; and
displaying an image including information that encodes the random secret and the session identifier.

5. The method of claim 1, wherein communicating the first signaling comprises:
displaying, at the second device, a user interface component for entering a one-time code displayed by the first device; and
receiving user input comprising the one-time code, wherein the first signaling comprising the new passkey is transmitted after receiving the user input.

6. The method of claim 5, wherein transmitting the indication that the import session is associated with the second device comprises:
transmitting the indication that the import session is claimed by the second device in accordance with reception of the user input.

7. The method of claim 6, further comprising:
displaying, at the first device, a second one-time code, wherein reception of the second signaling comprising the new passkey is based at least in part on displaying the second one-time code.

8. The method of claim 1, wherein the indication that the import session is associated with the second device comprises an identifier for the second device.

9. The method of claim 8, wherein receiving the second signaling is indicative of a confirmation of an identity of the second device based at least in part on the identifier for the second device.

10. The method of claim 1, further comprising:
transmitting third signaling to initiate a second import session for the blockchain wallet associated with the device-based passkey, wherein the third signaling comprises a second random secret; and
transmitting a second indication that the import session is canceled, wherein communicating the first signaling is based at least in part on transmission of the second indication.

11. The method of claim 1, wherein the new passkey is a device-based passkey associated with the first device, the new passkey is a cloud-based passkey associated with an operating system, or any combination thereof.

12. The method of claim 1, wherein the device-based passkey associated with the second device comprises a passkey for the second device, a passkey associated with a first operating system for the second device, or any combination thereof.

13. The method of claim 12, wherein the new passkey comprises a second device-based passkey associated with the first device, wherein the second device-based passkey comprises a passkey for the first device, a passkey associated with a second operating system for the first device, the second operating system different from the first operating system, or any combination thereof.

14. The method of claim 1, wherein the first signaling further comprises a session identifier, wherein transmission of the indication and reception of the second signaling is in accordance with the session identifier.

15. A second device, comprising:
one or more memories storing processor-executable code; and
one or more processors coupled with the one or more memories and individually or collectively operable to execute the code to cause the second device to:
communicate first signaling that initiates an import session between a first device and the second device for a blockchain wallet associated with a device-based passkey, wherein the first signaling comprises a random secret, and wherein the device-based passkey is associated with the second device;
transmit an indication that the import session is associated with the second device;
receive second signaling comprising an encrypted credential identifier associated with a new passkey for the blockchain wallet, wherein the new passkey is associated with the first device and wherein the encrypted credential identifier is encrypted based at least in part on the random secret;
sign a blockchain transaction authorizing access to the blockchain wallet using the new passkey, wherein authorizing access is based at least in part on the device-based passkey; and
transmit information indicative of the new passkey being authorized to access the blockchain wallet, wherein the blockchain transaction authorizing access to the blockchain wallet comprises adding the new passkey as owner of the blockchain wallet.

16. The second device of claim 15, wherein, to communicate the first signaling, the one or more processors are individually or collectively operable to execute the code to cause the second device to:
obtain, from an image sensor of the first device, an image including information that encodes the random secret.

17. The second device of claim 15, wherein, to communicate the first signaling, the one or more processors are individually or collectively operable to execute the code to cause the second device to:
transmit, to a manager service, third signaling comprising a session identifier associated with the import session; and
display an image including information that encodes the random secret and the session identifier.

18. The second device of claim 15, wherein, to communicate the first signaling, the one or more processors are individually or collectively operable to execute the code to cause the second device to:
display, at the second device, a user interface component for entering a one-time code displayed by the first device; and
receive user input comprising the one-time code, wherein the first signaling comprising the new passkey is transmitted after receiving the user input.

19. A non-transitory computer-readable medium storing code, the code comprising instructions executable by one or more processors to:
communicate first signaling that initiates an import session between a first device and a second device for a blockchain wallet associated with a device-based passkey, wherein the first signaling comprises a random secret, and wherein the device-based passkey is associated with the second device;
transmit an indication that the import session is associated with the second device, the indication comprising an identifier for the second device;
receive second signaling comprising an encrypted credential identifier associated with a new passkey for the blockchain wallet, wherein the new passkey is associated with the first device and wherein the encrypted credential identifier is encrypted based at least in part on the random secret; and
sign a blockchain transaction authorizing access to the blockchain wallet using the new passkey, wherein authorizing access is based at least in part on the device-based passkey.

20. The non-transitory computer-readable medium of claim 19, wherein the instructions are further executable by the one or more processors to:
transmit information indicative of the new passkey being authorized to access the blockchain wallet, wherein the blockchain transaction authorizing access to the blockchain wallet comprises adding the new passkey as owner of the blockchain wallet.
